(19) United States
(12) Patent Application Publication
(10) Pub. No.: US 2026/0289860 A1
(43) Pub. Date: Sep. 24, 2026

(54) SYSTEM

(71) Applicant: SoftBank Group Corp., Tokyo (JP)

(72) Inventor: Motoki MUTO, Tokyo (JP)

(73) Assignee: SoftBank Group Corp., Tokyo (JP)

(21) Appl. No.: 19/567,376

(22) Filed: Mar. 16, 2026

(30) Foreign Application Priority Data
Mar. 19, 2025 (JP) 2025-045117

(51) Int. Cl. G06T 11/60; G06F 40/284; G06F 40/30; G06F 40/40; G06N 3/0475

(52) U.S. Cl. CPC G06T 11/60; G06F 40/40; G06N 3/0475; G06F 40/284; G06F 40/30

(57) ABSTRACT

A system includes a processor that is configured to analyze input text using a natural language processing technique to generate a prompt sentence for instructing a generative artificial intelligence model to automatically generate an illustration, generate a comic including panel layout by applying a video generation technique using the generated illustration, and analyze a user emotion using an emotion analysis engine and, based on a result of the analysis, generate a prompt sentence for instructing the generative artificial intelligence model to generate an illustration and a panel layout suitable for the emotion.

### CROSS-REFERENCE TO RELATED APPLICATION

This application is based on and claims priority under 35 USC 119 from Japanese Patent Application No. 2025-045117 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional content production processes for comics, advertisements, and brand-related visual materials require extensive manual work by illustrators, designers, and editors. In particular, when a comic including panel layout must be created from a text description, a creator needs to interpret the text, design characters and scenes, determine panel layout, and repeatedly adjust the work to match an intended emotional tone or brand guideline. This manual workflow is time-consuming and costly, and it makes rapid prototyping or mass generation of customized content difficult.

Furthermore, in existing systems, automatic generation of illustrations by a generative artificial intelligence model from text input often lacks fine control over the emotional tone of the output. User emotions or target emotional impressions are not systematically analyzed and reflected in the generated illustrations and panel layouts. As a result, the generated content may not adequately match the emotional state of a user or the emotional requirements of a specific campaign.

In addition, when companies attempt to utilize specific characters for their own brands, there is a challenge in consistently adapting character designs to detailed brand guidelines, such as color schemes, logo placement rules, and character posture and expression policies. Existing tools provide limited support for automatically enforcing such guidelines in generated illustrations.

Moreover, when a joint venture is formed with an intellectual property (IP) holding company, there is a further challenge of systematically generating and commercially using content under license agreements. Current workflows often require manual checking of license conditions and manual adaptation of content to comply with licensing constraints, resulting in inefficiency and risk of non-compliance.

Therefore, there is a need for a system that, based on input text, can automatically generate prompt sentences for a generative artificial intelligence model, automatically generate comics including panel layout, reflect user emotions in the generated illustrations and panel layouts, adapt specific character designs to brand guidelines, and support commercial utilization of generated content under license agreements in a joint venture context.

### SUMMARY

To solve the above problems, according to one aspect of the present invention, there is provided a system comprising a processor, wherein the processor is configured to analyze input text using a natural language processing technique to generate a prompt sentence for instructing a generative artificial intelligence model to automatically generate an illustration. By structuring the input text into prompts suitable for the generative artificial intelligence model, the system enables automatic generation of illustrations corresponding to the semantic content and intent of the input text.

The processor is further configured to generate a comic including panel layout by applying a video generation technique using the generated illustration. Specifically, the processor can determine a sequence of scenes, allocate them to multiple panels, and arrange the panels on a page or screen, thereby converting the generated illustrations into a comic format or a storyboard format. This integrated processing reduces the need for manual panel design and layout work.

The processor is also configured to analyze a user emotion using an emotion analysis engine and, based on a result of the analysis, generate a prompt sentence for instructing the generative artificial intelligence model to generate an illustration and a panel layout suitable for the emotion. By incorporating the analyzed emotional state or target emotional tone into the prompts for the generative artificial intelligence model, the system can adjust character expressions, poses, colors, and panel composition so that the generated comic and illustrations better match the desired emotional impression.

In one embodiment, the processor is configured to adapt a design of a specific character to a brand guideline in order to utilize the specific character for a brand of a company. The processor may apply brand-specific constraints, such as designated color palettes, logo placement rules, and permissible variations of the character's appearance, when generating or post-processing illustrations. This configuration ensures that the automatically generated content remains consistent with corporate branding requirements while reducing manual adjustment by designers.

In another embodiment, the processor is configured to assume establishment of a joint venture company with a specific intellectual property holding company and commercially utilize generated content based on a license agreement. The processor may manage information on licensed IP characters and permitted usage types, and may control generation and export of content so that only licensed IP assets are used under the agreed conditions. By integrating license information and generation control, the system supports efficient and compliant commercial use of AI-generated content in collaboration with IP holders.

The term “processor” refers to one or more hardware processing units or circuits, such as a central processing unit (CPU), a graphics processing unit (GPU), a digital signal processor (DSP), or a combination thereof, configured to execute instructions and perform the functions described in the present specification.

The term “natural language processing technique” refers to a computational method or algorithm for analyzing, interpreting, or transforming human language text, including but not limited to tokenization, part-of-speech tagging, syntactic or semantic parsing, entity recognition, sentiment analysis, and text classification.

The term “prompt sentence” refers to a text or textual data structure generated by the processor and provided as an input condition to a generative artificial intelligence model, the prompt sentence specifying or constraining the content, style, or attributes of an illustration or other output to be generated by the generative artificial intelligence model.

The term “generative artificial intelligence model” refers to a machine learning model, such as a neural network or diffusion model, trained to automatically create new data, including images or illustrations, in response to input conditions such as prompt sentences.

The term “illustration” refers to a still image or graphical representation, including but not limited to drawings, paintings, or rendered images, which may contain characters, objects, backgrounds, or other visual elements used in comics, advertisements, packages, or related content.

The term “video generation technique” refers to a computational method or process that generates, composes, or edits moving image data, including, for example, animation synthesis, frame interpolation, storyboard conversion, or sequence arrangement based on one or more illustrations or images.

The term “comic” refers to a visual narrative work comprising a plurality of panels, typically including characters, scenes, and text elements such as dialogue or captions, arranged in a sequence to convey a story or message.

The term “panel layout” refers to an arrangement of one or more rectangular or polygonal regions, each region corresponding to a panel of a comic or storyboard, including their positions, sizes, and order on a page or display area.

The term “user emotion” refers to an emotional state, attitude, or affective response of a user, such as happiness, sadness, excitement, or calmness, which can be inferred or estimated from user input, behavior, or biometric signals.

The term “emotion analysis engine” refers to a software or hardware module configured to analyze data related to a user, such as text, voice, facial expressions, physiological signals, or interaction logs, to estimate or classify a user emotion.

The term “brand guideline” refers to a set of rules, specifications, or standards defined by a company or organization for maintaining consistency of a brand's visual and conceptual identity, including but not limited to color schemes, logo usage, typography, character appearance, and layout rules.

The term “character” refers to a fictional or stylized person, animal, object, or entity, having a defined visual design and personality, that may be used in illustrations, comics, advertisements, or other content as a recurring figure or mascot.

The term “intellectual property holding company” refers to a legal entity that owns or manages intellectual property rights, such as copyrights, trademarks, or character designs, and that may grant licenses for the commercial use of such intellectual property.

The term “joint venture company” refers to a business entity established by two or more parties, including at least one intellectual property holding company, for the purpose of jointly exploiting or managing specific businesses or projects, such as the commercial utilization of generated content.

The term “license agreement” refers to a legal contract or arrangement under which an intellectual property owner grants another party the right to use specified intellectual property, such as characters or designs, under defined conditions, including scope of use, duration, territory, or compensation.

The term “commercially utilize” refers to using generated content for business purposes, including but not limited to advertising, sales promotion, product packaging, merchandising, or other revenue-generating or brand-building activities.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

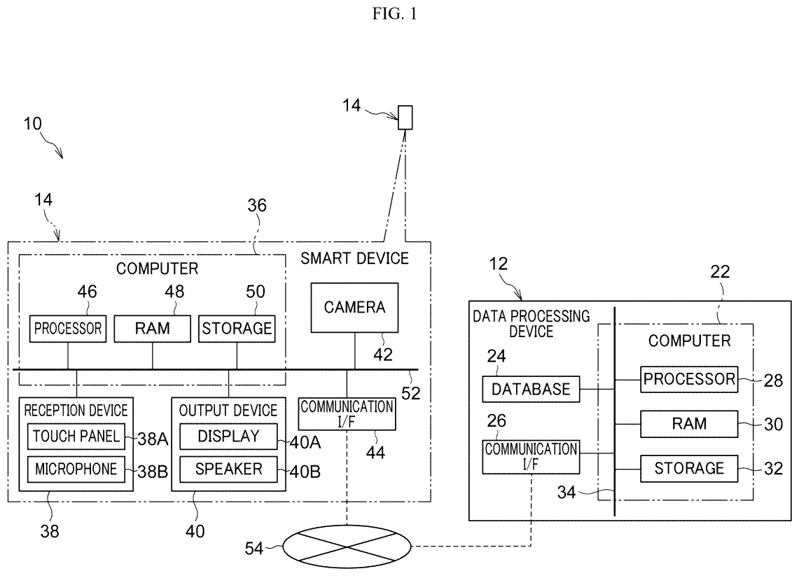

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

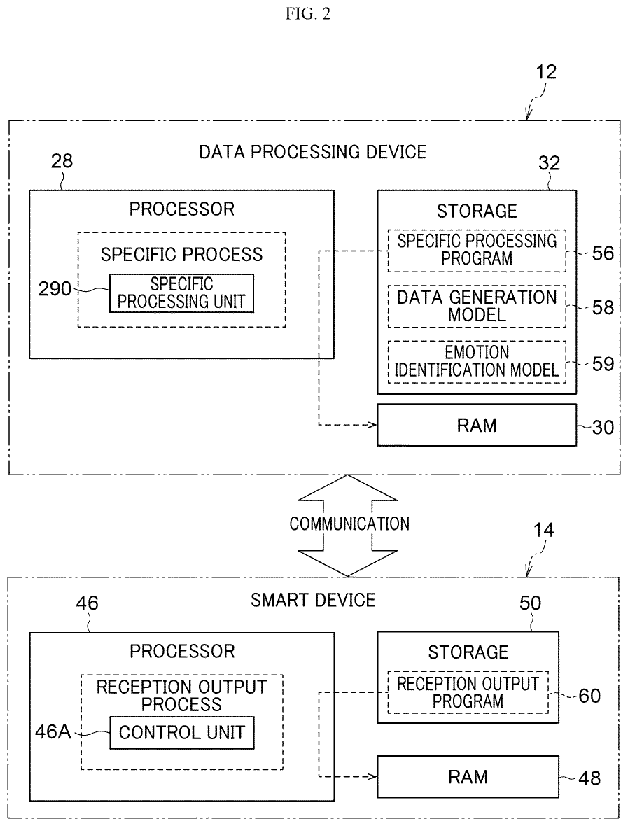

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented workflows for creating illustrated content, such as comics, advertising storyboards, and other panel-based visual narratives, rely heavily on manual authoring of prompts for generative AI models, manual arrangement of generated images into layouts, and ad hoc post-editing through separate tools. These workflows impose several technical limitations on information processing systems.

First, existing systems typically treat text analysis, prompt generation, image generation, layout computation, and revision as separate, loosely coupled processes. Because these processes are not integrated around a shared internal representation of user intent, a server often cannot reuse intermediate analysis results. As a consequence, the server must repeatedly re-interpret the same user input when the user requests revisions, causing redundant computation, higher latency, and inefficient use of processing resources.

Second, many current systems accept only a single-shot prompt for a generative AI model and generate images in isolation, without structured control over page size, panel arrangement, or panel order. In such systems, a server does not maintain layout metadata as first-class data, and therefore cannot automatically recalculate or partially update layouts in response to changes in user instructions. This limitation results in additional manual work for the user and prevents the server from efficiently performing incremental recomposition of content pages.

Third, known approaches provide little or no technical mechanism for the server to adapt generative AI model behavior based on user-specific affective signals and brand constraints in a unified manner. Emotion analysis, if present at all, is typically performed on the client side or in a separate module, and is not integrated into the generation of prompt sentences and layout information. Likewise, brand-related rules and rights-related usage conditions are often enforced outside the content generation pipeline, for example by manual review or separate policy engines, rather than by direct control over the generative AI model inputs and layout computations. This fragmentation leads to inconsistent outputs, increased risk of policy violations, and additional computational overhead for repeated filtering and correction. Fourth, when a user issues iterative instructions, such as modifying a character's appearance or changing a background scene, conventional systems frequently require full regeneration of all panels or pages because they lack a mechanism to localize the changes to a subset of structured elements and associated visual data. This full regeneration increases processing time, network traffic, and compute load on the server and on accelerators used by generative AI models.

Accordingly, there is a need for an improved computer-implemented content generation system in which a server maintains and updates a unified structured representation of user intent, uses that representation to automatically generate prompt sentences for generative AI models, computes and stores layout information as explicit data, and performs emotion-aware, brand-aware, and rights-aware control of both image generation and layout recomposition. Such a system should enable partial regeneration and reconstruction of content pages in response to incremental user instructions, thereby improving processing efficiency, reducing latency, and enhancing the technical performance of the overall content generation pipeline on the server side.

The specific processing by the specific processing unit 290 of the data processing device 12 in Example 1 is realized by the following means.

The present invention provides a server comprising a processor configured to receive language data input by a user via a terminal, analyze the language data by using a natural language processing algorithm, and extract structured information including at least a subject, key terms, an expression style, and a use purpose; automatically generate, on the server, a prompt sentence for input to a generative AI model for image generation based on the structured information, and cause the generative AI model to generate visual data according to the prompt sentence; automatically determine, on the server, layout information including at least a page size, panel arrangement, and panel order based on the visual data and the structured information, and automatically generate a content page including a plurality of panels by arranging the visual data according to the layout information; acquire, via the terminal, additional language data including instructions from the user regarding the content page or a generation process thereof, analyze, on the server, the additional language data to update the structured information, regenerate at least one of the prompt sentence and the visual data based on the updated structured information, and reconstruct at least a part of the layout information and at least a part of the content page according to a result of the regeneration; analyze emotion information related to the user by using an emotion analysis algorithm, and correct at least one of the prompt sentence and the layout information such that an expression style and a structure conform to the emotion information; store brand-related information including brand identification information and expression rules, and automatically adjust at least one of appearance attributes of an appearance target in the structured information, the prompt sentence, and the layout information such that the appearance attributes conform to the brand-related information; and refer to use condition information related to rights-target data, control at least one of generation and an output form of the visual data and the content page based on the use condition information, and manage the content page in a form commercially usable in accordance with a utilization permission agreement with a third party. This enables the server to implement an integrated, machine-controlled pipeline that transforms user language data into structured information, optimized prompt sentences, controlled generative AI model invocations, and explicit layout metadata, thereby allowing incremental regeneration and partial reconstruction of content pages with reduced redundant computation, improved latency, consistent application of emotion, brand, and rights constraints, and overall improved operation of the computer system.

The term “server” refers to an information processing apparatus including at least one processor and memory, configured to execute programs that perform reception, analysis, generation, layout computation, and transmission of data over a communication network.

The term “processor” refers to one or more hardware computation units, such as a central processing unit or a graphics processing unit, capable of executing instructions to perform arithmetic operations, logical operations, data transfers, and control operations.

The term “terminal” refers to a user-operated electronic device, such as a personal computer, a tablet device, or a mobile communication device, configured to send and receive data to and from the server and to provide input and output interfaces to the user.

The term “language data” refers to data representing natural language expressions, including at least character strings or encoded text that are input by a user or generated by the system.

The term “natural language processing algorithm” refers to a program or model that analyzes language data to determine semantic, syntactic, or pragmatic information, including identification of subjects, key terms, styles, and purposes.

The term “structured information” refers to information represented in a machine-readable format, such as a data structure or record, including at least fields for subject, key terms, expression style, and use purpose, derived from analysis of language data.

The term “subject” refers to a principal theme, concept, or topic extracted from language data, which characterizes an overall content to be generated.

The term “key terms” refers to one or more important words, phrases, or entities extracted from language data, which influence content generation, such as object names, actions, locations, or attributes.

The term “expression style” refers to a manner of visual or narrative expression, such as a genre, artistic style, tone, or level of realism, that is used as a parameter for generating visual data and layout information.

The term “use purpose” refers to an intended usage scenario for generated content, such as advertisement, education, entertainment, or internal communication, which affects generation parameters or constraints.

The term “generative AI model” refers to a machine learning model configured to produce new data, such as visual data, based on input data including at least a prompt sentence, by using learned statistical or neural network parameters.

The term “prompt sentence” refers to a natural language instruction or description provided as input to a generative AI model, specifying content, style, or constraints for data generation.

The term “visual data” refers to image data or graphical data generated by a generative AI model, including at least raster images, vector graphics, or intermediate image representations.

The term “layout information” refers to structured data describing spatial and logical arrangement of content elements on a page, including at least page size, panel arrangement, panel order, and coordinates or dimensions of regions.

The term “page size” refers to dimensional parameters, such as width and height, defining a spatial extent within which panels and other content elements are placed.

The term “panel arrangement” refers to a configuration specifying numbers, positions, and shapes of panels on a page, including relative placement and adjacency relationships between panels.

The term “panel order” refers to a sequence indicating a reading or viewing order of panels on a page, used to control narrative flow.

The term “content page” refers to a composite data unit representing at least one page that includes a plurality of panels, each panel containing visual data and optionally text or other elements, arranged according to layout information.

The term “additional language data” refers to language data received after initial generation of content, including at least user instructions for modification, refinement, or extension of previously generated content or processes.

The term “emotion information” refers to data indicating a user's emotional state or affective preference, derived from user input, behavioral signals, or analysis of language data.

The term “emotion analysis algorithm” refers to a program or model that processes emotion-related input, such as language data or behavior data, to identify or estimate emotional categories, intensities, or tendencies.

The term “appearance target” refers to an object, character, or element whose visual attributes, such as color, shape, costume, or markings, are subject to control by brand-related or style-related rules.

The term “brand-related information” refers to data describing identification information, design rules, and expression guidelines associated with a brand, including at least brand names, logotypes, color schemes, and permitted or prohibited visual patterns.

The term “appearance attributes” refers to visual characteristics of an appearance target, including at least form, color, pattern, size, pose, or accessories, which can be adjusted by the system.

The term “rights-target data” refers to data that is subject to intellectual property rights, usage rights, or contractual restrictions, including at least character designs, logos, artworks, or other protected materials.

The term “use condition information” refers to data describing conditions, limitations, or permissions for using rights-target data, such as allowed media, regions, durations, or modification rules.

The term “utilization permission agreement” refers to a contract or license arrangement under which a rights holder grants permission to use rights-target data under specified conditions, including at least commercial exploitation terms.

The term “output data” refers to data representing a final or intermediate form of a content page suitable for storage, transmission, or presentation, including at least image files, document files, or packaged digital assets.

The term “image format” refers to a digital encoding scheme for visual data, such as a bitmap format or vector format, suitable for rendering on a display device.

The term “document format” refers to a digital encoding scheme for representing one or more pages including visual and optionally textual content, such as a multipage file or structured document format.

The term “commercially usable form” refers to a state of data in which generated content has been processed, controlled, or annotated such that it complies with applicable use condition information and can be offered, distributed, or licensed for commercial purposes.

In one embodiment, a server includes at least one processor, a main memory, a non-volatile storage device, and a network interface connected to a communication network. The server executes an operating system such as a UNIX-based system or a general-purpose server operating system, and runs application software implemented, for example, in a programming language such as Python or JavaScript. The server optionally uses acceleration hardware such as a graphics processing unit for neural network inference. A terminal operated by a user includes a processor, a display device, an input interface such as a touchscreen or keyboard, and a network communication module. The terminal runs a web browser or a native application to interact with the server via a secure communication protocol such as HTTPS over TCP/IP.

The server stores program modules in the non-volatile storage device and loads them into the main memory for execution. The program modules include at least: a natural language processing module, a prompt sentence generation module, a generative AI model interface module, a layout computation module, an emotion analysis module, a brand and rights control module, and a content composition module. The server further stores one or more trained generative AI models or has access to such models via a remote inference service. In one example, the server uses a large-scale transformer-based language model comparable to GPT-4 as a natural language processing model, and a diffusion-based image generation model comparable to DALL·E or Stable Diffusion as a generative AI model for visual data. The server uses a structured data model in main memory to manage user intent and intermediate results. In one embodiment, the server represents structured information as a record including fields such as “subject”, “key_terms”, “expression_style”, “use_purpose”, “characters”, “scenes”, and “constraints”. Each field is stored, for example, as a key-value entry in a dictionary-like structure, where values may be strings, numeric scores, or lists of tokens. The server maintains, for each content generation job, a job object that includes the structured information, references to generated visual data, and layout information. The job object is stored both in main memory and in a persistent data store such as a relational database.

The server uses the natural language processing module to analyze language data received from the terminal. The natural language processing module applies a tokenization process, in which the module maps character sequences into token identifiers using a predefined vocabulary. The module then feeds the token sequence into a transformer-based neural network. This network includes an embedding layer converting token identifiers into continuous vectors, multiple self-attention layers, feed-forward layers, and layer normalization units. The self-attention layers compute context-aware representations by calculating attention weights using dot products between query, key, and value vectors, and then aggregating values according to these weights. The feed-forward layers perform non-linear transformations to capture complex patterns. The module decodes the final hidden representations to produce labels such as subject candidates, key term candidates, and style descriptors. The server applies a deterministic post-processing algorithm that aggregates model outputs, computes confidence scores, and resolves conflicts using rule-based priority. This design improves precision and consistency in extracting structured information because the transformer network captures long-range dependencies in the input text, and the post-processing algorithm stabilizes the model's probabilistic outputs.

The server uses the prompt sentence generation module to construct a prompt sentence for the generative AI model. The module reads the structured information fields and formats them using templates stored in a template repository. For example, when the subject is “eco-friendly running shoes advertisement”, the expression style is “modern sports manga”, and the use purpose is “promotion for young adults”, the module can generate a prompt sentence such as:

“Generate a four-panel manga in a modern sports manga style. Show a young adult runner discovering eco-friendly running shoes, training in a green city environment, and feeling motivated and powerful. Use dynamic poses, motion lines, and a stylish, cool color palette. Include a subtle, fictional brand logo on the shoes.”

In some embodiments, the server uses the language model itself to refine the prompt sentence. The prompt sentence generation module converts the structured information into an intermediate description and passes it as input to a transformer-based model that has been fine-tuned for prompt optimization. The model outputs a candidate prompt sentence, which the module evaluates using heuristic rules, such as checking for required fields (style, number of panels, key objects) and maximum length constraints. The server selects or edits the candidate prompt sentence to meet internal standards. By formalizing prompt sentence generation as a deterministic pipeline combined with neural refinement, the server reduces variability and improves the relevance of prompts compared to manual human-crafted prompts.

The server uses the generative AI model interface module to communicate with the image generation model. In one embodiment, the server sends the prompt sentence, along with parameters such as target resolution, number of images, and random seed, to a diffusion-based model. The diffusion model internally represents an image as a multi-channel tensor and iteratively refines noise into a coherent image by applying a denoising network conditioned on the text embedding of the prompt sentence. The server receives the generated visual data as a binary image buffer, decodes it using an image processing library, and stores it in memory. The interface module maintains a mapping between each visual data unit and the corresponding part of the structured information, enabling the layout module to associate images with specific panels, characters, or scenes without re-parsing the input text.

The server uses the layout computation module to create layout information. The module defines a two-dimensional coordinate system for each content page and represents layout information as a list of panel objects, each including fields such as “panel_id”, “x”, “y”, “width”, “height”, and “reading_order_index”. The module applies a layout algorithm that takes into account the number of scenes, the importance of each scene (derived from key term weights in the structured information), and device characteristics such as display aspect ratio. For instance, the module may allocate larger panels to scenes with higher importance scores and position introductory panels in the top-left region. The module ensures that panels do not overlap and that gutters between panels maintain a minimum margin. By computing layout information as explicit coordinates and ordering metadata, the server enables deterministic rendering and partial updates.

The server uses the emotion analysis module to adjust both prompt sentences and layout information based on emotion information related to the user. In one embodiment, the server receives additional language data from the terminal, such as “I want this to feel more dramatic and inspiring.” The emotion analysis module applies a sentiment and emotion classifier implemented as a neural network trained on labeled emotion datasets. The network uses text embeddings and outputs probabilities for categories such as “joy”, “sadness”, “excitement”, and “calmness”. The server converts the probabilities into an emotion vector and uses it to modify style parameters, such as increasing contrast, changing color palette descriptors in the prompt sentence, or adjusting panel sizes to emphasize dramatic scenes. Since the server incorporates this emotion vector directly into both textual and spatial parameters, the system achieves consistent emotion-aware adjustments that would be difficult to realize by human manual editing alone.

The server uses the brand and rights control module to ensure that generated content complies with brand-related information and use condition information. The module maintains a repository of brand identification data, visual guidelines, and rights constraints. For example, the repository may specify that a logo must appear in at least one panel, that only certain color combinations are allowed, or that specific character poses are restricted. The module cross-references the structured information and layout information with these rules. When the subject includes an appearance target linked to a brand, the module modifies the prompt sentence to include explicit instructions such as “Include a minimal, clean logo on the shoe side, using only blue and white colors.” The module also restricts the output formats or resolutions based on rights-target conditions, for example allowing only non-editable document formats for certain licensed characters. This integrated control within the generative pipeline prevents inconsistent or non-compliant outputs and reduces the need for post-generation filtering.

The server uses the content composition module to synthesize final content pages. The module reads the visual data and layout information and renders each panel into a page buffer. In one embodiment, the server uses a graphics library to allocate an off-screen drawing surface and draw panel borders, place images at the coordinates specified in the layout information, and optionally reserve regions for text captions. The module can combine multiple pages into a multi-page document file or export individual page images. Because the server holds all layout parameters explicitly, it can recompute and redraw only the affected regions when updates occur, avoiding full-page recomposition and thereby reducing computational load.

The terminal presents a user interface that guides the user through content creation and refinement. The terminal displays input fields for language data and provides controls for selecting style preferences and use purpose. The terminal also displays previews of generated content pages by downloading composed images or documents from the server. The user can provide additional language data, such as “Make the main character look older and change the background to a nighttime city.” The terminal sends this data to the server along with identifiers of the relevant content pages or panels.

The server updates the structured information when additional language data is received. The natural language processing module re-analyzes the new input but uses the existing structured information as context. For example, if the original subject and key terms remain valid, the server modifies only the “characters” and “scenes” fields. The server then regenerates only those prompt sentences that correspond to the affected panels and calls the generative AI model to generate new visual data for those panels. The layout computation module updates only panel objects whose content changed. The content composition module redraws only the modified panels into the existing page buffer. This incremental update mechanism improves processing efficiency compared to regenerating all visual content, lowers the amount of data transmitted over the network, and reduces response time for iterative user interactions. The system provides specific technical improvements over conventional approaches. By representing user intent as structured information, and by coupling that information to both prompt sentence generation and layout computation, the server reduces redundant analyses and computations across iterations. The server avoids repeated full-text parsing and full-page rendering by localizing updates to affected elements. This leads to reduced processor utilization and shorter end-to-end latency in generating updated content. The explicit layout information and job object structures also enhance data management, because the server can track which visual data fragments relate to which parts of the structured information, enabling efficient caching and reuse.

The generative AI models are trained using standard supervised or self-supervised learning procedures but are tailored to the described pipeline. For the language model, the server or an associated training system uses a corpus of text annotated with subjects, key terms, styles, and purposes. The training system defines a loss function such as cross-entropy over the annotated labels and performs gradient-based optimization, for example using an adaptive learning rate algorithm. For the image model, the training system uses pairs of text descriptions and images. The diffusion model is trained with a noise prediction objective, where the model learns to predict the noise added to images at various diffusion timesteps, and the loss function is the mean squared error between predicted noise and actual noise. Weights of the neural networks are updated through backpropagation. In some embodiments, the system applies data augmentation techniques, such as random cropping or color jittering, to increase robustness. These technical details ensure that the generative AI models are effective at mapping from structured, prompt-based descriptions to consistent visual outputs within the constraints imposed by emotion, brand, and rights modules.

The server uses non-conventional control logic to integrate the models. Instead of simply passing user text directly to a generative AI model, the server decomposes the process into analysis, structuring, prompt generation, and layout computation. This decomposition is not merely an automation of human tasks; it exploits the capabilities of neural networks and formalized data structures to achieve machine-level optimization. For example, by using attention-based mechanisms and explicit panel importance scores, the server can algorithmically adjust panel sizes and positions to reflect semantic salience, something that is not a straightforward manual translation of human workflow.

The system achieves reduction of communication load because the server transmits only final or incrementally updated content to the terminal, rather than all intermediate visual candidates. The terminal displays the final or updated content on its display device using its graphics subsystem, rendering images or documents received from the server. When the user requests changes, the terminal sends concise language data and identifiers, rather than full-resolution image data. This division of labor reduces the network bandwidth required and centralizes heavy computation on the server where specialized hardware may be available. Alternative embodiments are also possible. In one variant, the server hosts the generative AI models locally, using GPU hardware, while in another variant, the server accesses external inference services but still maintains the same structured information and layout control. In another embodiment, the terminal may have a local cache of certain standard assets, such as brand logos or template layouts, and the server transmits only references or minimal metadata, which the terminal uses to compose some elements locally. In yet another embodiment, the server can support different neural network architectures, such as recurrent neural networks or convolutional networks, as long as these architectures provide sufficient capability to extract structured information and generate visual data in response to prompt sentences.

The described system may be applied to various technical fields where panel-based content is required, such as digital publishing, interactive tutorials, and multi-screen signage. In each use, the server's coordinated management of structured information, prompt sentences, generative AI models, and explicit layout information leads to improved computational performance, higher fidelity to user intent, and better control over technical constraints such as resolution, aspect ratio, and device compatibility. Through these mechanisms, the invention provides a concrete improvement in computer technology for content generation systems, beyond mere business automation.

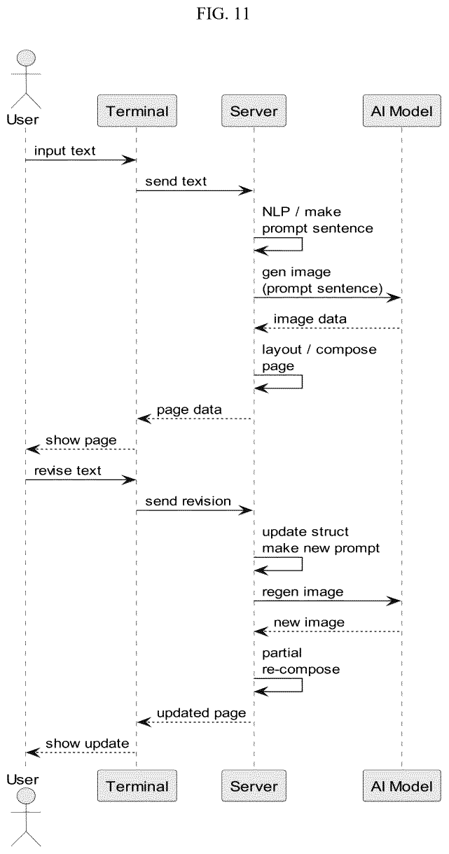

The following describes the processing flow using FIG. 11.

### Step 1

The user operates the terminal to input initial language data.

The terminal displays an input form and receives a text string such as “Create a four-panel manga advertising new eco-friendly running shoes for young adults, with a cool and inspirational tone.” as input.

The terminal performs basic validation on the input (for example, checking that the text length is greater than a minimum threshold) and associates the text with a newly generated session identifier.

The terminal outputs a structured request message including at least the session identifier and the language data, and transmits this message to the server via a network connection.

### Step 2

The server receives the request message from the terminal.

The server parses the message to extract the session identifier and the language data as input.

The server stores the raw language data and session metadata in a persistent data store as a new job record, and generates a job identifier as output.

The server sends a response to the terminal containing the job identifier and an initial status indicator, thereby confirming that processing has started.

### Step 3

The server analyzes the language data using a natural language processing algorithm.

The server takes, as input, the text string from the job record and converts it into a token sequence using a tokenizer.

The server feeds the token sequence into a transformer-based language model and computes, through matrix multiplications and attention operations, contextual embeddings for each token.

The server applies a decoding layer and rule-based post-processing to extract structured information fields, including at least a subject, key terms, an expression style, and a use purpose, as output.

The server stores the structured information in association with the job identifier in the data store.

### Step 4

The server generates a prompt sentence for a generative AI model based on the structured information.

The server uses, as input, the subject, key terms, expression style, and use purpose fields from the structured information.

The server selects a template corresponding to a panel-based content type and fills template slots by concatenating the field values with connector phrases, performing string operations such as insertion and substitution.

The server may refine the resulting text by sending it to a language model configured for prompt optimization and then applying heuristic checks.

The server outputs a finalized prompt sentence, such as “Generate a four-panel manga in a modern sports manga style. Show a young adult runner discovering eco-friendly running shoes, training in a green city environment, and feeling motivated and powerful. Use dynamic poses, motion lines, and a stylish, cool color palette. Include a subtle, fictional brand logo on the shoes.” and stores it with the job record.

### Step 5

The server invokes a generative AI model for image generation using the prompt sentence.

The server provides, as input to the generative AI model interface module, the prompt sentence, target resolution parameters, and a random seed.

The server transmits these parameters to a diffusion-based image generation model, which, through iterative denoising computations on multi-dimensional tensors, produces one or more images whose semantics correspond to the prompt sentence.

The server receives the generated image data as a binary buffer or encoded string, decodes the data into image objects, and performs optional image processing such as resizing or format conversion.

The server outputs visual data objects and associates each object with the job identifier and, if applicable, with scene or panel indices.

### Step 6

The server computes layout information for a content page based on the structured information and the visual data.

The server uses, as input, the number of images, importance scores derived from key terms, device or page size constraints, and preferred reading order.

The server executes a layout algorithm that allocates rectangular panel regions on a virtual page by calculating x and y coordinates, widths, and heights for each panel while ensuring non-overlap and margin constraints.

The server orders panels by assigning a reading_order_index according to narrative progression inferred from the subject and scenes in the structured information.

The server outputs layout information as a list of panel records containing identifiers and coordinate data, and stores this information with the job record.

### Step 7

The server composes a content page by placing visual data according to the layout information.

The server takes, as input, the visual data objects and the panel coordinate data.

The server allocates a page buffer in memory with dimensions matching the page size and uses a graphics library to draw panel borders and render each image into its corresponding coordinate region.

The server may leave reserved areas for text or logos by not drawing images in designated subregions.

The server outputs a composed page image or a set of page images, encodes them in an image or document format, and stores references to these outputs in the data store.

### Step 8

The server analyzes emotion information related to the user and adjusts generation parameters.

The server uses, as input, either explicit emotion-related language data (for example, “make it more dramatic”) or prior interaction logs associated with the session.

The server feeds this input into an emotion analysis model that computes emotion category scores through vector embedding and classification operations.

The server maps the resulting emotion vector to adjustments of style descriptors in the structured information and weight parameters in the layout algorithm, such as increasing panel size for emotionally intense scenes or modifying color-related phrases in the prompt sentence.

The server outputs updated structured information, modified prompt sentences, or modified layout parameters and records these changes for subsequent generations or revisions.

### Step 9

The server enforces brand-related information and rights conditions during content generation.

The server takes, as input, the structured information (including any appearance targets), the current prompt sentence, and a set of brand and rights rules stored in a rules repository.

The server performs rule matching by comparing identifiers and attributes in the structured information and layout information against conditions in the rules repository, using comparisons and logical operations.

The server modifies the prompt sentence, for example by adding constraints such as “use only blue and white colors for the logo” or “place the logo in one panel background,” and restricts allowable output formats based on rights conditions.

The server outputs a compliant prompt sentence and output configuration, and uses these adjusted values for subsequent invocations of the generative AI model and for content export.

### Step 10

The server sends the composed content page to the terminal for display.

The server uses, as input, the composed page images or document files and the job identifier.

The server generates a response message containing URLs or binary data of the composed outputs and updates the job status to indicate availability.

The terminal receives the response, decodes or downloads the page data, and renders the pages on the display using a graphics subsystem.

The terminal outputs the visual content to the user, enabling the user to review the generated manga or illustration.

### Step 11

The user reviews the displayed content and provides additional language data for revisions. The user observes the content on the terminal display and decides on modifications, such as “Make the main character older and change the background to a nighttime city.”

The terminal captures this additional language data as input, along with identifiers of the job and, optionally, specific panels.

The terminal packages the additional language data and identifiers into a revision request message and transmits the message to the server.

The terminal outputs the revision request to initiate an update cycle.

### Step 12

The server updates structured information and regenerates affected prompt sentences and visual data.

The server uses, as input, the revision request containing additional language data and panel or job identifiers.

The server re-analyzes the additional language data with the natural language processing algorithm, merges the results with the existing structured information by updating only relevant fields such as character attributes and scene descriptions, and produces updated structured information as output.

The server identifies which panels depend on the modified fields by checking associations between panel records and structured information elements.

The server regenerates new prompt sentences for only the affected panels, calls the generative AI model again with these prompt sentences, receives new visual data for those panels, and replaces the corresponding visual data objects in the job record.

### Step 13

The server partially reconstructs the layout and recomposes the content page.

The server uses, as input, the updated visual data for affected panels and the existing layout information.

The server determines whether panel coordinates must change based on updated importance scores or scene relationships; if so, the server recalculates coordinates only for impacted panels or regions.

The server redraws the content page by updating only the modified regions in the page buffer, overlaying new images in place of old ones and preserving unchanged panels.

The server outputs an updated composed page, encodes it as an image or document, and updates the corresponding output references in the data store.

### Step 14

The terminal retrieves and displays the updated content page.

The terminal uses, as input, a notification or a status query response from the server indicating that revised content is available.

The terminal requests the updated page data, receives the new image or document, and replaces the previously displayed version with the updated version on the display.

The terminal may briefly highlight changed panels to indicate revisions to the user.

The terminal outputs the revised content for further review or acceptance by the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that produce visual advertising materials from text input typically treat natural language processing, image generation, and layout authoring as disjoint stages that require substantial manual intervention. A typical workflow requires a human creator to interpret textual marketing requirements, manually craft detailed prompt sentences for a generative AI model, iteratively adjust the prompts to obtain acceptable images, and then manually design comic-style panel layouts and place the images and text on a page. This fragmented workflow leads to several technical problems in computer-based content generation.

First, existing systems generally lack an integrated mechanism in which a processor automatically transforms raw character information into machine-usable, structured semantic data that can directly and efficiently condition a generative AI model. As a result, the computational pipeline is not optimized: the generative AI model often receives under-specified or noisy prompt sentences that do not sufficiently encode advertisement-specific subject information, attribute information, and emotional context. This causes unnecessary re-generation cycles, inefficient usage of processing resources such as central processing units and graphics processing units, and increased end-to-end latency.

Second, conventional image generation systems typically focus only on producing standalone images and do not automatically infer or optimize a page-level frame arrangement structure (panel division) on the basis of image content. The absence of automated detection of main target regions and content-aware frame arrangement forces manual editing in dedicated authoring tools. This manual intervention not only reduces throughput and scalability but also prevents efficient, repeatable computation of comic-style layouts that are adapted to the generated content. The underlying computer system is thereby limited in its ability to automatically compose complex, multi-panel visual narratives from generated images.

Third, existing systems generally do not feed user emotional state back into the computational pipeline in a structured, model-driven manner. While some systems may allow subjective human adjustment of prompts, they do not analyze user emotion using an emotion analysis engine and do not automatically update prompt sentences or layout control parameters on the basis of such analysis. As a result, computing resources are not systematically directed toward generating images and panel divisions that are better aligned with user emotion, which limits personalization, reduces the effectiveness of the generated advertisement content, and fails to exploit the full potential of adaptive generative AI.

Fourth, current systems that deploy comic-style advertisement content across heterogeneous distribution media (for example, different device classes or channels) often rely on separate, manual export configurations. Computing components are not configured to automatically convert a unified comic-format advertisement into multiple output formats and resolutions while maintaining brand identification information and service identification information in a consistent and machine-controlled manner. This leads to redundant processing, increased risk of inconsistent branding, and suboptimal utilization of server-side computing capabilities. Accordingly, there is a need for an improved computer-implemented system and processing method that: (i) automatically analyzes input character information to extract advertisement-related semantics; (ii) automatically generates structured prompt sentences for a generative AI model; (iii) automatically generates visual expression images and content-aware panel divisions based on detected main target regions; (iv) automatically incorporates user emotion analysis into prompt generation and layout control; and (v) automatically composes, brands, and outputs comic-format advertisement content in multiple distribution-ready formats. By addressing these limitations, the invention improves the functioning of the computer system itself as a content generation platform, enabling more efficient, adaptive, and scalable computational processing for generating comic-style advertisement content.

The specific processing by the specific processing unit 290 of the data processing device 12 in Application Example 1 is realized by the following means.

The present invention provides a server comprising a processor configured to analyze input character information by using natural language processing technology to extract subject information and attribute information related to an advertisement; to automatically generate a prompt sentence, by using a generative information processing model, for causing generation of a visual expression having a specific style on the basis of the subject information and the attribute information; to convert the prompt sentence from character information into feature data, to input the feature data as a condition to an image generation generative information processing model, and to generate a visual expression image having the specific style; to detect a main target region included in the visual expression image by using image processing technology, to determine a page-level frame arrangement structure on the basis of the main target region, and to automatically generate panel division by allocating a plurality of visual expression images according to the frame arrangement structure; to synthesize the visual expression images on a page canvas according to the panel division and to superimpose character information including at least advertisement information on the page canvas to generate advertisement content in a comic format; to transmit the generated advertisement content to a user terminal via a communication device and to cause the user terminal to display the advertisement content; to analyze a user emotion by using an emotion analysis information processing engine; and, on the basis of an analysis result, to automatically generate, additionally or update-wise, a prompt sentence for causing the generative information processing model to generate a visual expression image and panel division adapted to the emotion. This enables the server to implement an integrated, computer-implemented pipeline in which semantic analysis, prompt sentence generation, content-aware image generation, automated panel layout, and emotion-adaptive refinement are executed cooperatively by the processor, thereby improving the overall computational efficiency, adaptability, and scalability of generating comic-format advertisement content across heterogeneous distribution media.

The term “processor” refers to a hardware information processing component, such as a central processing unit, a graphics processing unit, a digital signal processor, or a combination thereof, that executes instructions to perform the functions described in the present specification and claims.

The term “character information” refers to information expressed as text data, including but not limited to alphanumeric characters, symbols, and punctuation, that is input by a user or obtained from an external source and used as input to natural language processing.

The term “natural language processing technology” refers to a set of computational techniques and models for analyzing and interpreting human language character information, including operations such as tokenization, part-of-speech tagging, parsing, semantic analysis, and extraction of structured information.

The term “subject information” refers to structured data representing a main topic, object, or theme inferred from input character information, such as a product category, service type, or central concept of an advertisement.

The term “attribute information” refers to structured data representing properties, features, or characteristics associated with subject information, such as quality attributes, functional attributes, emotional attributes, or contextual attributes extracted from input character information.

The term “advertisement information” refers to information related to promotion or communication of products, services, brands, organizations, or messages, including but not limited to slogans, benefit statements, usage scenarios, and target audience indications.

The term “generative information processing model” refers to a computational model that is configured to generate new data instances, such as text data or image data, on the basis of learned parameters and input conditions, and includes, for example, generative neural network models and probabilistic generative models.

The term “prompt sentence” refers to character information that is structured as an instruction or description and is provided as input to a generative information processing model to control or condition the content, style, or structure of data to be generated.

The term “image generation generative information processing model” refers to a generative information processing model specifically configured to generate image data, such as a generative adversarial network, a diffusion model, or another neural network-based image generator, conditioned on input features or prompt sentences.

The term “visual expression” refers to a representation in image form, including an illustration, drawing, or graphic element, that visually depicts content related to subject information, attribute information, or advertisement information.

The term “visual expression image” refers to digital image data that encodes a visual expression as pixel values or an equivalent representation and that is generated, processed, or stored by the system.

The term “specific style” refers to a pattern of visual expression characterized by particular stylistic features, such as line quality, shading, composition, or character design conventions, learned or emulated by a generative information processing model.

The term “feature data” refers to numerical or symbolic data representing characteristics of input information, such as vector embeddings or feature vectors obtained by encoding a prompt sentence or other character information for use as conditions to a generative information processing model.

The term “image processing technology” refers to computational techniques for analyzing, transforming, or synthesizing digital image data, including operations such as filtering, detection, segmentation, resizing, and compositing.

The term “main target region” refers to a region within a visual expression image that is determined to be of primary importance, such as a region containing a principal character, object, or logo, and that is used as a basis for layout or panel arrangement decisions.

The term “page-level frame arrangement structure” refers to layout information defining positions, sizes, and shapes of multiple frames or panels on a page canvas, for arranging a plurality of visual expression images in a comic-style composition.

The term “panel division” refers to the partitioning of a page canvas into multiple discrete regions or frames, each region being configured to contain one or more visual expression images or character information as part of a comic-style layout.

The term “page canvas” refers to a two-dimensional digital workspace, defined by pixel dimensions or physical dimensions, on which visual expression images, panel borders, and character information are arranged and composited to form a page of content.

The term “comic format” refers to a structured visual presentation format in which content is arranged into multiple panels or frames on a page canvas, often combined with textual elements such as dialogue or narration, to convey a sequential or narrative structure.

The term “user terminal” refers to an information processing apparatus operated by a user, such as a personal computer, a smartphone, a tablet device, or another client device, that communicates with the server to input character information and display advertisement content.

The term “communication device” refers to a hardware and software component or interface used by the server to transmit and receive data over a wired or wireless communication network, including network interface controllers, communication modules, and associated protocols.

The term “emotion analysis information processing engine” refers to a computational module configured to analyze input data, such as character information, user interaction data, or audio-visual data, and to infer an emotional state or emotional attribute associated with a user.

The term “user emotion” refers to an emotion-related state or attitude of a user, such as happiness, excitement, anxiety, or disappointment, which is inferred or estimated by the emotion analysis information processing engine.

The term “expression features” refers to characteristic properties or patterns associated with a particular creative style, including stylistic aspects of line work, color usage, composition, character proportions, or other visual conventions that a generative information processing model is trained to emulate.

The term “specific creative style” refers to a set of expression features that collectively define a recognizable visual or artistic style, which is learned or approximated by a generative information processing model for use in generating visual expression images.

The term “brand identification information” refers to information used to identify a brand, such as brand names, logos, taglines, or other brand-specific symbols or design elements.

The term “service identification information” refers to information used to identify a service, such as service names, service marks, or descriptive labels associated with a particular service offering.

The term “distribution media” refers to different channels or media types through which advertisement content is provided or displayed, including but not limited to web pages, mobile applications, printed materials, digital signage, and social networking services.

The term “outputtable data” refers to data that is stored in a format suitable for being output, transmitted, or rendered by an information processing apparatus or a distribution medium, including image files, document files, and multimedia files.

In one embodiment, a server executes a computer program that implements the claimed system by cooperating with at least one user terminal over a communication network. The server includes a processor, a main memory, a storage device, and a network interface. The user terminal includes a processor, a display device, an input device, a main memory, and a communication module. The server processor executes a server-side program stored in the storage device, and the user terminal processor executes a client-side program or web browser that provides a graphical user interface for entering character information and displaying generated advertisement content in a comic format.

The server uses a general-purpose central processing unit and, in some embodiments, one or more graphics processing units to perform computationally intensive operations. The server installs and executes software components including an operating system, a web server, an application framework implemented in a general-purpose programming language, and software libraries for natural language processing, neural network computation, and image processing. The server, for example, uses an application framework implemented in a high-level language for request handling, a machine learning framework such as a tensor computation library or a dynamic computation graph library for neural networks, and an image processing library such as a computer vision library for image manipulation and analysis.

The server stores in its storage device a plurality of trained neural network models that implement different generative AI models and analysis engines. The server stores at least: a natural language processing model for semantic extraction from character information; a text-to-embedding encoder model that converts prompt sentences into numerical feature vectors; an image generation generative AI model, such as a generative adversarial network or a diffusion-type network; an object detection or saliency detection model for identifying main target regions in generated visual expression images; and an emotion analysis model that infers a user emotion based on user inputs or feedback. Each model has an associated model configuration, including network architecture definition, learned parameter sets, and inference-time hyperparameters.

The server uses a natural language processing model that, in one embodiment, comprises a multi-layer transformer-based encoder. The server configures the transformer-based encoder to receive tokenized character information and produce contextual embeddings. The server stores a vocabulary mapping from character sequences to token identifiers in the storage device. The server, during deployment, loads the vocabulary and word embedding matrices into the main memory and uses them to convert input character information into integer token sequences and then into dense vector embeddings. The transformer-based encoder includes multiple self-attention layers, layer normalization components, and feedforward sublayers, and outputs a sequence of contextual representations as well as a pooled representation that summarizes the content. The server applies additional dense layers to the pooled representation to derive subject information and attribute information, such as an embedding that encodes the product category and a separate embedding that encodes attributes like quality, function, and emotion.

The server constructs a specific data structure in the main memory for holding the results of the natural language processing. The server stores in this structure fields such as a subject field, an attributes field, an emotion field, and a context field. The subject field stores an identifier or short text describing the main product or service. The attributes field stores a list of attribute strings and associated numerical weights indicating importance. The emotion field stores one or more emotion labels and their confidence values, and the context field stores situational tags, such as “sports,” “education,” or “daily life.” By structuring the data in this manner, the server enables later modules to access advertisement-related semantics efficiently without repeatedly parsing the original free-form text.

The server generates a prompt sentence by applying a generative AI model that is separate from, but interoperable with, the natural language processing model. In one embodiment, the server uses a decoder-only transformer neural network as a text generation model. The server prepares an input sequence for the generator by concatenating tokenized subject information, attribute information, and optionally original user character information, along with control tokens indicating the desired output style and level of detail. The server then executes an auto-regressive generation algorithm in which the transformer predicts the next token conditioned on previously generated tokens. The server employs beam search or nucleus sampling to balance diversity and quality of the generated text. This procedure results in a complete prompt sentence that includes detailed instructions for image generation.

For example, when the user enters character information such as:

“New running shoes that are lightweight and comfortable. I want a dynamic manga-style advertisement.”

the server generates a prompt sentence such as:

“Create a vibrant manga illustration in the style of a specific comic artist. Show a young runner sprinting along a riverside path at sunset, wearing sleek, lightweight running shoes. Emphasize speed and comfort with strong motion lines, wind effects, and a bright, energetic color palette. Make sure the shoes are clearly visible and detailed, and convey a sense of freedom and excitement.”

In another example where the user intends to promote a coffee shop, the server generates a prompt sentence such as:

“Create a four-panel manga in the style of a specific comic artist. The story should promote a new neighborhood coffee shop that offers a warm and cozy atmosphere. In the first panel, show a main character looking tired after work, walking down a quiet street. In the second panel, show the character noticing the new coffee shop with a softly glowing sign. In the third panel, show the character enjoying a cup of coffee inside the shop, with warm lighting and detailed latte art. In the fourth panel, show the character leaving with a smile, thinking, ‘I will come back here again.’ Emphasize warmth, relaxation, and the shop's logo.”

The server converts each prompt sentence into feature data suitable for conditioning an image generation generative AI model. In one embodiment, the server uses a separate text encoder network co-trained with the image generator. This text encoder may be based on a transformer or recurrent architecture that outputs a fixed-dimensional embedding vector. The server normalizes the embedding vector, for example by L2-normalization, and stores the vector in memory as a conditional feature. Compared to directly embedding raw character information, re-encoding a structured prompt sentence yields a condition vector with higher semantic density and explicit style directives, which improves control of the image generator and reduces the number of iterations needed to achieve a desired output. This improves computational efficiency on the server by reducing GPU time per final usable image.

The server implements the image generation generative AI model as a neural network that maps from random latent noise and conditional feature vectors to image tensors. In one embodiment, the server uses a conditional generative adversarial network architecture, wherein a generator network receives a concatenated vector of random noise and the prompt-embedding feature, and produces an image tensor, while a discriminator network evaluates whether the image appears realistic and consistent with the condition. During training, the server (or an offline training system) adjusts the parameters using an adversarial loss combined with a conditional consistency loss that encourages the generated image to match the prompt sentence semantics. In another embodiment, the server uses a conditional diffusion model that iteratively denoises an image sample guided by gradients computed from a denoising network that receives the conditional feature vector.

The server loads trained generator network parameters into GPU memory at startup and uses them for inference only. The generator network includes multiple convolutional layers, upsampling operations, normalization layers, and non-linear activation functions that expand a low-dimensional latent vector into a high-resolution image. By conditioning the generator on the prompt-embedding feature, the server causes the network to produce visual expression images that exhibit a specific style and content structure requested in the prompt sentence. Because the network is trained with a large dataset annotated with style and content labels, the server can obtain images that match high-level advertisement semantics in fewer iterations than manual trial-and-error prompting. This yields a reduction in processing time and more predictable use of computing resources.

The server applies image processing technology to the generated visual expression images to detect main target regions. The server, for example, uses an object detection neural network such as a convolutional detection architecture to identify bounding boxes around characters, products, or logos. The detection network outputs bounding box coordinates and class scores, which the server records in the main memory as region structures. The server may also compute saliency maps using gradient-based or attention-based methods to identify areas that attract visual focus. The server combines these results to determine a “main target region” for each image, defined as a bounding box covering the most relevant subject.

The server determines a page-level frame arrangement structure by analyzing the main target regions across a plurality of generated images. The server uses a layout algorithm that considers the importance of each image (e.g., as determined by confidence scores, user emotion scores, or keyword emphasis) and assigns larger frames to more critical content. The layout algorithm arranges rectangular frames on a page canvas such that important regions remain unobstructed and visible. For example, the server may place an image whose main target region is tall and narrow in a vertical frame and place an image whose main target region is wide in a wide horizontal frame. The server uses a rule set that differs from conventional fixed templates by dynamically adjusting frame sizes and positions based on the detection results. This content-aware layout method improves visual coherence and reduces manual rearrangement, thereby improving computational effectiveness of layout generation. The server generates panel division by mapping each visual expression image to a frame within the frame arrangement structure. The server resizes and crops each image using an image processing library so that the main target region fits within the assigned frame while preserving visual context. The server uses anti-aliased resampling to avoid quality degradation and calculates cropping boundaries to ensure that critical elements, such as faces or products, are not truncated. The server then composites the resized images onto a digital page canvas by writing pixel values into corresponding regions. The server draws panel borders using vector drawing operations provided by the image processing library. This compositing process yields a multi-panel page image representing a comic format.

The server superimposes character information, including at least advertisement information, onto the page canvas. The server, for example, selects positions for slogans, narration, and dialogue based on the empty space areas identified by the saliency analysis. The server uses text rendering capabilities to draw campaign slogans near the main product, and may add speech balloons by drawing polygonal or elliptical shapes with outlines and placing text inside. The server chooses font sizes and styles according to device resolution and target distribution medium. By integrating text placement into the same computational pipeline that performs panel division and image placement, the server reduces the risk of overlap and produces layouts that respect both visual composition and readability constraints, thus improving the overall technical quality of the rendered image.

The server analyzes user emotion using an emotion analysis information processing engine. The server, for example, receives user feedback in the form of textual comments, rating selections, or reaction tags from the user terminal. The server applies the natural language processing model or a separate classifier to the feedback text to determine an emotion label and intensity. The emotion analysis engine may be implemented as a neural network classifier trained on labeled emotion data, outputting probabilities for classes such as “joy,” “surprise,” or “disappointment.” The server stores the emotion data in association with the corresponding generation request. When generating a subsequent prompt sentence, the server includes the emotion label and intensity as additional conditioning information. For example, if the user emotion is estimated as “insufficient excitement,” the server increases weights on attributes such as “dynamic,” “impactful,” and “vibrant” in the structured semantic representation, and the prompt generation model adjusts its output to produce more energetic scene descriptions.

This feedback-based adjustment changes the distribution of condition vectors supplied to the image generator, which in turn leads to different image compositions and panel divisions. By embedding emotion-based adaptation into the machine-level pipeline rather than relying on manual prompt rewriting, the server achieves more systematic personalization and reduces the number of human editing cycles. This contributes to improved computation efficiency and reduced network traffic between the server and user terminal, since fewer intermediate previews need to be transmitted.

The server transmits the completed advertisement content in a comic format to the user terminal via the communication device. The server may store the final composite page as an image file such as a bitmap-based format or a vector-enhanced document, and generate links or data streams suitable for different distribution media. The server may, for example, generate a high-resolution version for printing, a medium-resolution version for web display, and a lower-resolution version for mobile applications. The server automatically converts the image size, compression parameters, and metadata to conform to target media requirements while preserving brand identification information and service identification information embedded within the content. By centralizing conversion logic in the server and employing structured metadata for brand and service identifiers, the system avoids manual reconfiguration per medium and reduces the risk of inconsistent branding, thereby improving reliability of digital asset management.

The user operates the terminal to input character information, preview generated content, and optionally provide feedback. The user terminal, in one embodiment, runs a browser or native application that transmits input character information, receives rendered page images or previews, and displays them on the display device. The user terminal may provide controls for zooming, scrolling, and selecting alternate versions. The user may change the advertisement theme, message, or desired emotional tone, and submit updated requests to the server. The user terminal may also provide an interface for selecting target distribution media, in which case the server adapts output formats accordingly.

The terminal uses its communication module to send and receive data packets over a wired or wireless network to the server's network interface. The terminal may cache some received advertisement content locally for faster redisplay, but the main computational tasks, including semantic analysis, generative AI processing, and layout calculation, are performed by the server. This division of labor allows the server to leverage specialized hardware such as GPUs and large memory while keeping the terminal lightweight.

In additional embodiments, the server uses alternative network architectures for the generative AI model. For instance, the server may employ a hybrid model where a transformer-based text encoder is coupled to a diffusion-based image generator that performs iterative denoising over time steps. The server controls the number of denoising steps and sampling schedule to trade off between image quality and generation speed. The server may also employ data augmentation during training, such as random cropping, horizontal flipping, and color jittering, to improve robustness of the image generator and object detector. During fine-tuning, the server minimizes a loss function that combines reconstruction loss, adversarial loss, style loss, and semantic alignment loss, which encourages closer correspondence between text embeddings and visual features.

The server, by structuring data flows through specialized modules with well-defined intermediate representations, achieves improved computational performance compared to a naive, monolithic implementation. The server's decision to first convert raw character information into structured semantic fields, then into a prompt sentence, and finally into numerical feature vectors reduces noise and ambiguity at each stage. This layered transformation leads to more stable input distributions for the neural networks, improves convergence of the models during training, and reduces inference-time variability. As a result, the server achieves faster average generation times per usable advertisement page and higher semantic accuracy between user intent and final comic-format content.

The system, therefore, does not merely automate human artistic tasks; instead, the server reconfigures the internal computation of a multi-module content generation pipeline. The server optimizes data structures, neural network conditioning, and layout decisions to exploit machine-level advantages such as parallel processing and precise numerical optimization. The resulting improvements in processing speed, generation accuracy, computational resource utilization, and layout coherence constitute technical effects on the functioning of the computer system itself, and enable technical uses in generating and distributing complex comic-format advertisement content across diverse devices and media.

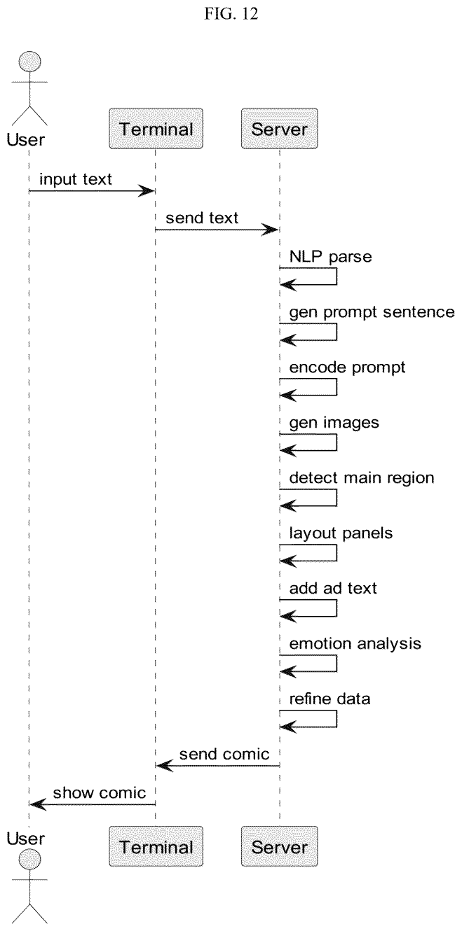

The following describes the processing flow using FIG. 12.

### Step 1

The user operates the terminal to input advertisement-related character information. The user enters, for example, an advertisement theme and message into a text field such as “New running shoes that are lightweight and comfortable. I want a dynamic manga-style advertisement.” The terminal receives this character information as input, performs basic validation to ensure that the text is not empty and within a predefined length, and then packages the text into a request structure. The terminal sends this request structure as output to the server via a communication network using a network protocol.

### Step 2

The server receives the request structure from the terminal through its network interface. The server takes as input the character information and associated metadata contained in the request. The server parses the request using an application framework, decodes the character information from the transport format, and stores the raw text in main memory and optionally in persistent storage together with a request identifier. The server outputs a normalized text string and an associated request context object that will be used as input to subsequent processing.

### Step 3

The server uses a natural language processing model to extract semantic information from the normalized text string. The server takes as input the normalized text and converts it into a token sequence by applying a tokenizer that maps characters and words to integer token identifiers. The server feeds this token sequence into a transformer-based encoder implemented in a neural network library, and performs matrix multiplications and attention computations to obtain contextual embeddings. The server applies additional classification layers to these embeddings to derive subject information, attribute information, emotion-related cues, and contextual tags. The server outputs a structured semantic representation, which includes fields for subject, attributes, emotion, and context, as the result of this data transformation.

### Step 4

The server constructs a prompt sentence by applying a text generation generative AI model. The server takes as input the structured semantic representation and the original normalized text. The server formats these inputs into a control sequence that includes tokens representing the subject information, attribute information, desired style indicators, and any emotion-related modifiers. The server feeds this control sequence into a decoder-only transformer network and performs auto-regressive prediction of next-token probabilities, using either beam search or sampling, to generate a coherent prompt sentence. The server outputs a complete prompt sentence in character form, such as “Create a vibrant manga illustration in the style of a specific comic artist. Show a young runner sprinting along a riverside path at sunset, wearing sleek, lightweight running shoes. Emphasize speed and comfort with strong motion lines, wind effects, and a bright, energetic color palette. Make sure the shoes are clearly visible and detailed, and convey a sense of freedom and excitement.”

### Step 5

The server converts the prompt sentence into feature data for conditioning an image generation generative AI model. The server takes as input the prompt sentence text and applies a text encoder network that tokenizes the sentence and maps tokens to embeddings. The server passes these embeddings through multiple encoder layers to compute a fixed-dimensional feature vector that summarizes the prompt semantics and style directives. The server then normalizes this feature vector, for example by scaling it to unit length, and stores it as a conditional feature representation. The server outputs this feature vector as numerical feature data that will serve as conditioning input to the image generation model.

### Step 6

The server generates visual expression images using an image generation generative AI model. The server takes as input the conditional feature vector and one or more random latent noise vectors sampled from a predefined probability distribution. The server concatenates or otherwise combines the conditional feature vector with each latent noise vector to form an extended latent input, and feeds this to a neural network generator comprising multiple layers of convolutions, upsampling operations, and non-linear activations. The generator performs a sequence of tensor operations to transform each extended latent input into an image tensor. The server converts each image tensor into an image file format by scaling pixel values and encoding them as a standard image format. The server outputs one or more visual expression images that reflect the content and style requested in the prompt sentence.

### Step 7

The server analyzes each generated visual expression image to detect one or more main target regions. The server takes as input the image files and loads them into memory as pixel matrices using an image processing library. The server passes these matrices to an object detection or saliency detection model that performs convolutional operations to compute feature maps and predict bounding boxes or saliency scores. The server identifies, for each image, the bounding box with the highest relevance score as a main target region, representing, for example, a principal character or a product. The server outputs a set of region descriptors that include coordinates and importance scores for each main target region.

### Step 8

The server determines a page-level frame arrangement structure for comic-style panel division based on the main target regions. The server takes as input the region descriptors for all images intended for a page and their associated importance scores. The server executes a layout algorithm that calculates positions and sizes of panel frames on a page canvas, considering the aspect ratios and locations of main target regions. The server uses rules and heuristics to assign larger frames to more important images and to align frames so that main target regions are not clipped or overlapped. The server outputs a frame arrangement structure that defines the coordinates and dimensions of each panel on the page canvas.

### Step 9

The server generates panel division and composes the page canvas using the visual expression images and the frame arrangement structure. The server takes as input the visual expression images and the panel coordinates. The server resizes each image using resampling operations so that the main target region fits within the assigned panel while maintaining aspect ratio, and crops or pads the image as necessary. The server writes the resized image data into the appropriate region of a blank page canvas, and draws panel borders along the calculated frame boundaries using drawing primitives. The server outputs a composite page image where the visual expression images are arranged in multiple panels in a comic format.

### Step 10

The server overlays advertisement-related character information onto the composite page image. The server takes as input the structured semantic representation, including subject information and advertisement information, and the composite page canvas. The server selects suitable positions for text elements by analyzing empty or low-saliency regions on the canvas and matching them with text length and importance. The server uses text rendering routines to draw slogans, product names, and narration onto the canvas, optionally drawing shapes for speech balloons or caption boxes before placing text inside them. The server outputs a finalized advertisement content image in comic format that combines images, panel borders, and text.

### Step 11

The server applies emotion analysis results to refine subsequent prompt sentences and layouts. The server takes as input user feedback or interaction data received from the terminal, such as user comments or ratings related to the generated advertisement content. The server processes this input with an emotion analysis model that classifies the feedback into emotion labels and intensities by applying neural network computations to the tokenized text or input signals. The server updates the structured semantic representation with emotion-related fields and adjusts weights assigned to attributes such as “dynamic,” “warm,” or “serious.” The server outputs updated semantic data that is used as input for generating a new or revised prompt sentence, thereby refining future visual expression images and panel divisions in a manner adapted to the detected user emotion.

### Step 12

The server prepares distribution-ready versions of the finalized advertisement content and transmits them to the user terminal. The server takes as input the finalized composite page image and target distribution parameters, such as desired resolution and format for web, mobile, or print media. The server generates multiple output variants by resizing, re-encoding, and, if necessary, embedding metadata containing brand identification information and service identification information. The server stores these variants in storage and selects an appropriate variant based on the requesting terminal type. The server sends the selected image or document data to the terminal via the communication interface. The terminal receives this output, decodes the image or document, and renders the advertisement content on its display device for the user to view.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for creating advertising and packaging designs that include specific characters generally rely on manual authoring tools and static asset libraries. In such systems, a human operator is required to perform a series of discrete operations: interpret textual requirements, formulate prompts for a generative AI model, invoke the model, collect the generated images, select appropriate candidates, and then manually adapt the selected images to brand guidelines and emotional tone. This workflow introduces technical inefficiencies in the way computing resources are used and in the way data flows between components of the system.

First, known systems do not tightly integrate natural language processing, generative AI models, and storage subsystems in a unified processing pipeline. As a result, the input text is often passed to the generative AI model in a raw or suboptimal form, and the mapping from user input to model-ready prompt sentences must be manually adjusted. This leads to repeated trial-and-error invocations of the generative AI model, causing unnecessary computational load on processing hardware such as central processing units and graphics processing units, and increases network traffic and storage operations.

Second, conventional systems do not provide a mechanism within the computing architecture to dynamically modify prompt sentences or generative AI model parameters based on machine-analyzed user emotion. Emotional adaptation is typically performed implicitly by human designers, rather than by the system itself. This results in a disconnect between user feedback and the generative process at the system level, and prevents the system from efficiently converging on outputs that are aligned with the user's emotional state. From a computer-technology standpoint, this manifests as an inability of the system to automatically optimize generation parameters across successive inference operations based on measured emotional responses.

Third, existing systems lack an integrated mechanism by which the computing system applies brand guideline constraints and licensing conditions at the time of generation and storage. Brand adaptation, such as enforcing color tone, character shape, and arrangement rules, is largely performed in separate design tools, downstream of image generation. Similarly, license conditions relating to a specific intellectual property are typically managed in external document or rights management systems, detached from the image-generation pipeline. This fragmented architecture causes redundant data transformations, inconsistent application of brand and license rules, and makes it difficult to programmatically control or audit how generated content is stored and later reused. In particular, databases and storage resources are not systematically linked with the parameters used during generation, which impedes scalable and automated commercial use.

Fourth, prior systems often handle user terminals as thin clients that merely upload text and retrieve images, without a coordinated, processor-driven mechanism to present multiple candidates and obtain structured selection feedback from the user. Consequently, selection information is not effectively exploited as structured data to improve subsequent processing. This leads to suboptimal utilization of computational resources because the system cannot efficiently prioritize or reuse high-value outputs, and it impairs the ability of the system to manage large volumes of generated visual representations in a way that benefits downstream design software.

Accordingly, there is a need for a technical solution that reconfigures how a processor controls natural language processing, generative AI model invocation, emotion analysis, brand constraint enforcement, storage, and user interaction, so that the overall computer system performs these combined tasks more efficiently and more consistently. The challenge is to provide a system-level architecture and specific processor operations that (i) convert raw text input into model-ready prompt sentences in an automated and optimized manner, (ii) automatically adapt generation behavior using emotion analysis of the user, (iii) enforce brand and license constraints at the point of generation and storage, and (iv) structure the interaction with the user terminal so that selection of generated candidates is integrated into the data processing pipeline.

The specific processing by the specific processing unit 290 of the data processing device 12 in Example 2 is realized by the following means.

The present invention provides a server comprising a processor configured to analyze input text information by using natural language processing to generate a prompt sentence for instructing a generative AI model to automatically generate a visual representation, to input the prompt sentence to the generative AI model and automatically generate, based on numerical computation processing by the generative AI model, a visual representation including a specific character and a composition of the visual representation, to store the automatically generated visual representation and the composition in a storage resource in an information processing apparatus as basic data for an advertising design or a packaging design, to generate the advertising design or the packaging design by using design editing software to automatically place the visual representation of the specific character into an advertising layout or a packaging layout on the basis of the stored visual representation and the composition, to control communication with a terminal operated by a user so as to transmit, from the terminal to the server, the prompt sentence input by the user through a communication function, to cause the terminal to acquire a plurality of visual representation candidates generated at the server, and to accept, as structured selection data, a selection operation by the user for one of the plurality of visual representation candidates, to analyze an emotion of the user by using an emotion analysis engine and dynamically change content of the prompt sentence or instruction parameters to the generative AI model according to an analysis result so that a visual representation and a composition suitable for the emotion of the user are generated, to apply brand constraint conditions including at least one of color tone, shape, and arrangement rules to the prompt sentence or to the generated visual representation and the composition so that the specific character is adapted to a brand guideline, and to manage the visual representation and the composition generated by the generative AI model in association with license condition information and accumulate the visual representation, the composition, and the license condition information in the information processing apparatus in preparation for commercial use in a wide range of applications. This enables an integrated computer-implemented pipeline in which the server-side processor converts raw text into optimized prompt sentences, interacts programmatically with the generative AI model, applies emotion-based and brand-based constraints during generation, structurally manages user selection feedback from the terminal, and stores generation outputs together with associated license information, thereby improving the efficiency, consistency, and controllability of computing resources used for generation, selection, and utilization of character-based advertising and packaging designs.

The term “processor” refers to a hardware computing element, such as a central processing unit or graphics processing unit, and associated control logic that executes instructions to perform data processing operations specified by software or firmware. The term “input text information” refers to character-based digital data, including words, phrases, or sentences, that is received from a user or another system and used as a basis for subsequent natural language processing and prompt generation.

The term “natural language processing” refers to a class of computational techniques and algorithms that analyze, interpret, and transform human language text into structured data or normalized representations suitable for further machine processing.

The term “prompt sentence” refers to a text string or structured text data that is generated by the processor and provided as an instruction or condition to a generative AI model in order to influence or control the content and style of an output generated by the model.

The term “generative AI model” refers to a machine learning model, such as a neural network, trained to produce new data instances, including at least image data, in response to input conditions such as a prompt sentence, by performing numerical computation.

The term “visual representation” refers to image data, including at least characters, objects, backgrounds, or other graphical elements, that can be rendered on a display or printed medium and that is generated or processed by the system.

The term “specific character” refers to a particular visual entity, such as a stylized person, animal, or mascot, having characteristic attributes and used as a recognizable element within a brand, product, or content series.

The term “composition” refers to an arrangement relationship between visual elements, including at least position, size, orientation, and relative layout of the specific character and other elements within the visual representation.

The term “numerical computation processing” refers to a sequence of mathematical operations, including matrix multiplications, non-linear transformations, and probabilistic sampling, executed by hardware such as a processor or accelerator to perform inference by a generative AI model.

The term “information processing apparatus” refers to a computer system, including at least one processor, memory, and storage, configured to perform data storage, retrieval, and management operations in association with the system.

The term “storage resource” refers to a physical or logical data storage component, such as a memory device, database, or object storage, used to persistently store visual representations, compositions, and associated metadata.

The term “basic data for an advertising design or a packaging design” refers to digital image data and layout-related information that are generated or stored by the system and used as a starting point or core element in constructing an advertising layout or a packaging layout.

The term “design editing software” refers to an application program or software tool capable of loading, displaying, and modifying image data and layout data to create or edit advertising or packaging designs.

The term “advertising layout” refers to a structured arrangement of graphical and textual elements intended for promotional display, including at least a specific character, product information, and message text, within a spatial frame such as a page or screen.

The term “packaging layout” refers to a structured arrangement of graphical and textual elements configured to be printed or otherwise applied to a physical container, wrapper, or label for a product.

The term “terminal” refers to an end-user device, such as a personal computer, smartphone, or tablet, equipped with input and output interfaces and communication capabilities, used by the user to interact with the system.

The term “communication function” refers to a hardware and software capability that enables the transmission and reception of data between the terminal and the server over a communication network, using protocols such as HTTP or other network protocols.

The term “server” refers to a computing apparatus or group of computing apparatuses that provides processing, storage, and communication services to one or more terminals over a network.

The term “visual representation candidate” refers to one instance of a generated visual representation produced by the generative AI model in response to a prompt sentence, where multiple such instances can be generated as alternatives.

The term “selection operation” refers to a user input action, such as a click, tap, or other input, indicating a choice of one or more visual representation candidates among a plurality of candidates.

The term “structured selection data” refers to data describing the result of a user's selection operation in a machine-readable format, including at least an identifier of a selected visual representation candidate and associated context information.

The term “emotion analysis engine” refers to a software module or set of algorithms that estimate or classify a user's emotional state on the basis of input data such as text, voice, facial image, or interaction patterns.

The term “emotion of the user” refers to a psychological state or affective condition of the user, represented in the system as one or more categories or continuous values, such as positive, negative, neutral, or more fine-grained emotional labels.

The term “instruction parameters to the generative AI model” refers to configuration values provided to the generative AI model in addition to the prompt sentence, including at least parameters relating to style, strength of conditioning, resolution, or number of generated candidates.

The term “brand constraint conditions” refers to rules or parameter values defining restrictions or requirements derived from a brand guideline, including at least color tone limitations, shape characteristics, typography rules, and element arrangement patterns.

The term “brand guideline” refers to a set of predefined rules or specifications that define consistent use of brand-related visual elements, including at least color schemes, logos, character styles, and layout policies.

The term “color tone” refers to image-related properties such as hue, saturation, brightness, or related color parameters applied to the visual representation or to a part of the visual representation.

The term “shape” refers to a geometric characteristic of visual elements, including contour, proportion, and structural form of the specific character or other graphical components.

The term “arrangement rules” refers to constraints or patterns specifying relative positions, spacing, and alignments of visual elements within a layout, such as preferred placement of the specific character, logos, and text.

The term “license condition information” refers to data describing legal or contractual conditions for use of generated content, including at least allowed usage fields, duration, territory, and limitations on modification or redistribution.

The term “wide range of applications” refers to multiple usage scenarios and media types, including but not limited to online advertising, printed advertising, product packaging, and other marketing or promotional materials.

The term “attribute information for identifying the specific character” refers to data that specifies characteristics of the specific character, such as name, category, appearance features, or version identifiers, used to uniquely distinguish the character.

The term “joint business entity” refers to a legal or organizational structure formed by at least two parties, such as companies or institutions, for collaborative commercial activities relating to intellectual property.

In one embodiment, a server cooperates with one or more terminals operated by users to implement the claimed system. The server includes at least one processor, a main memory, a non-volatile storage device, and a network interface. The processor may be implemented by a multicore central processing unit and one or more graphics processing units or dedicated accelerators. The memory stores program modules that, when executed by the processor, cause the server to perform the functions described below. The non-volatile storage device may include a relational database and an object storage system. The network interface enables bidirectional communication with the terminals via a communication network.

A terminal includes an input device, an output device, a network interface, and a local processor. The local processor executes a web browser or a dedicated application that provides a user interface for entering a prompt sentence, transmitting data to the server, and displaying generated visual representation candidates. The terminal may be realized by a general-purpose computing device such as a personal computer, a smartphone, or a tablet. The server uses a natural language processing module to analyze input text information received from the terminal. The natural language processing module may be implemented using a library that supports tokenization, part-of-speech tagging, and sentence normalization. The server converts user-entered text into a normalized prompt sentence suitable for a generative AI model. For example, the server may receive a prompt sentence such as: “Summer campaign visual for our beverage brand using our official character, refreshing blue and green colors, character smiling and holding a cold drink, space on top for slogan text.” The server normalizes this prompt sentence by performing operations such as lowercasing, removal of extraneous whitespace, and inclusion of additional model directives. The server may append a phrase such as “illustration style, suitable for advertising layout, with clear area for text” to ensure that the generative AI model produces a visual representation that is consistent with advertising usage.

The server uses a tokenizer to transform the normalized prompt sentence into a sequence of tokens. The tokenizer divides the text into subword units and maps each subword to an integer identifier. The server constructs a data structure that contains, for each prompt sentence, a token identifier sequence, an attention mask indicating valid token positions, and generation parameters such as desired image resolution, number of denoising steps, and guidance strength. The server passes this data structure to a generative AI model. In one implementation, the generative AI model is a diffusion-based neural network that generates images conditioned on textual embeddings. The server uses a text encoder, which may be a transformer-based neural network, to convert the token identifier sequence into a high-dimensional embedding vector sequence. The server then supplies this embedding sequence to a denoising network that iteratively transforms random noise into an image. The denoising network may have a U-shaped convolutional architecture with skip connections and self-attention modules. The server configures the model with a defined number of denoising iterations, such as 50 or 100 steps. At each iteration, the model refines a noisy image representation based on the text conditioning, reducing a noise measure according to a learned noise prediction function.

The server uses a loss function such as a mean squared error between predicted noise and true noise during training of the generative AI model, and applies an optimization algorithm such as stochastic gradient descent with adaptive learning rate adjustment to update the model parameters. During inference, the server uses the trained parameters and does not modify them, but adjusts guidance scale parameters and step schedules to trade off speed and quality. These settings are part of the instruction parameters to the generative AI model.

The server stores the generated image data as pixel arrays in an internal format and then encodes the image data into a compressed file format such as PNG or JPEG. The server writes the encoded images to an object storage system, and registers corresponding metadata in a relational database. The metadata includes, for each generated visual representation: a prompt identifier, user identifier, generation timestamp, model configuration parameters, brand-related flags, and license condition information. The server thereby constructs an indexed repository of visual representations and compositions that can be efficiently queried based on multiple attributes. This structured repository improves data management by enabling retrieval of images according to specific character identifiers, campaigns, or license constraints without scanning all stored files.

The server additionally maintains brand guideline information and brand constraint conditions in a structured data form. Brand guideline information may include color specifications, allowed shapes and proportions for a specific character, and arrangement rules indicating preferred positions and spaces for logos and text. The server applies these conditions in two ways. First, the server modifies the prompt sentence itself before model invocation, inserting explicit instructions such as “use brand primary colors,” “maintain character proportion,” and “reserve left-side area for logo and text.” Second, after image generation, the server analyzes the generated images using computer vision operations to verify compliance with brand constraints, such as checking dominant colors via color histograms or verifying relative positions of key regions. When necessary, the server discards non-conforming candidates or marks them as low priority, reducing the number of images that must be manually checked by a human operator.

The server uses an emotion analysis engine to estimate the user's emotional state based on input data obtained during interaction with the terminal. In one embodiment, the terminal sends user feedback text or rating data after displaying generated candidates. The server applies a sentiment analysis model, which may be a classifier based on a recurrent neural network or transformer architecture, to the feedback text. The classifier outputs scores for emotional categories such as positive, neutral, or negative. The server uses these scores as parameters to adjust subsequent prompt sentences and generative model settings. For example, if negative sentiment is detected for a first set of candidates, the server increases the intensity of “dynamic” or “cheerful” keywords in the next prompt sentence, and adjusts the model's style parameters to emphasize brighter color tones.

The server thereby implements a closed-loop adaptation procedure. Rather than a human designer manually inferring how user emotion should alter design choices, the server uses structured emotional feedback and rule-based mappings to dynamically adjust token weights, add or remove descriptive phrases, and adjust sampling parameters. This non-conventional procedure modifies not only the content of the prompt sentence but also the numerical guidelines provided to the generative AI model. As a result, the server converges on suitable visual representations with fewer generation cycles, reducing total GPU computation time and communication load between the server and the terminal.

The terminal displays multiple visual representation candidates retrieved from the server and accepts user selection operations for one or more preferred candidates. The terminal encodes the selection events as structured selection data that includes candidate identifiers and context information such as selection rank or time. The server stores this selection data in the database linked to the corresponding prompt sentences and generation parameters. In subsequent processing, the server uses the accumulated selection data to bias parameter settings; for example, the server increases the probability of reusing specific styles or compositions that have previously been selected frequently by users for similar prompt sentences. This feedback mechanism improves the efficiency of the computing process by reducing the generation of low-value candidates and focusing computational resources on configurations that are historically effective.

The server associates each generated visual representation with license condition information. The license condition information describes where and how the visual representation can be used, including permitted media types, geographical regions, and time periods. The server maintains these conditions in the database and links them to the corresponding image identifiers. When the terminal requests an image for use in a new campaign, the server checks the license condition information and only returns images whose conditions are compatible with the requested usage. This technical arrangement ensures that the selection of images complies with license constraints without requiring external manual checking systems, thereby reducing the risk of serving inappropriate content and reducing the need for repeated data transfers of unusable images.

The server generates layout data for advertising or packaging designs by programmatically combining the generated visual representations with template layouts. The server stores template data that specify positions of image placeholders, text fields, and logos. The server reads a selected visual representation, determines its aspect ratio and size, and then calculates a scaling factor and placement coordinates that satisfy arrangement rules defined in the template. The server outputs composite layout data that can be opened by design editing software. This computational arrangement reduces manual adjustment steps and standardizes the placement of the specific character across multiple materials.

In another embodiment, the server uses different types of generative AI models for distinct purposes. For example, the server may use a first model that generates rough concept sketches at low resolution, and then a second model, such as a super-resolution model or style refinement model, that enhances selected sketches into high-resolution, brand-conforming images. The server thereby divides processing between coarse exploration and fine refinement stages. This staged architecture optimizes computational efficiency because high-cost refinement is applied only to a reduced set of candidates that have been prefiltered using prompt-based guidance, emotion analysis, and brand constraint checks.

The server, by tightly integrating natural language processing, generative image modeling, emotion analysis, brand constraint enforcement, and license-aware storage, modifies the way computing hardware is used to create and manage character-based advertising and packaging designs. The server reduces redundant calls to the generative AI model by using normalized prompt sentences and feedback-based parameter adjustments, thereby shortening processing time and lowering power usage of the processor. The server improves accuracy of generated outputs with respect to brand guidelines and user emotion by structurally incorporating constraint data and emotional scores into the parameter space of the generative process. Additionally, the server enhances data management by maintaining linked records of prompts, model parameters, user selections, and license conditions, allowing subsequent retrieval and reuse of assets without repeated generation. These effects arise from the specific cooperation among the server, the terminal, and the described modules, rather than from a generic automation of human tasks.

In yet another embodiment, the server is configured to support different data structures and algorithms for representing prompt sentences. For example, the server may represent a prompt sentence not only as a single text string but also as a structured object that divides content into fields such as “character attributes,” “background context,” “mood,” and “layout requirements.” The server uses rule-based mappings to adjust each field separately based on brand guideline data and emotion analysis output. The generative AI model receives a combined representation where certain token groups are emphasized via higher conditioning weights. This structured approach enables the processor to perform fine-grained control over different aspects of the generated visual representation, producing more stable and predictable compositions.

The user operates the terminal to input various prompt sentences depending on intended campaigns. For instance, the user may input:

“Sports brand advertisement featuring our mascot character, powerful running pose, urban night background.”

or

“Create a fresh and friendly summer campaign character for a beverage brand, standing beside a cold drink with splashing water, bright blue and yellow color palette.”

The terminal sends these prompt sentences to the server, which processes them through the described pipeline, generates multiple candidates, and returns structured results. Because the server implements optimization and constraint logic at the computing level, the system provides consistent behavior even when different users supply diverse textual descriptions. This consistency improves the predictability of resource usage and facilitates scalable deployment in environments where many terminals and users are concurrently generating designs.

By providing these embodiments, the server, the terminal, and the user interaction are combined into a concrete arrangement that improves operation of the underlying computer system itself. The natural language processing, generative AI model execution, emotion analysis, brand constraint handling, and license-aware storage are performed in a coordinated, non-conventional sequence that optimizes data flow, reduces unnecessary computation, and enhances the technical reliability of the generated outputs.

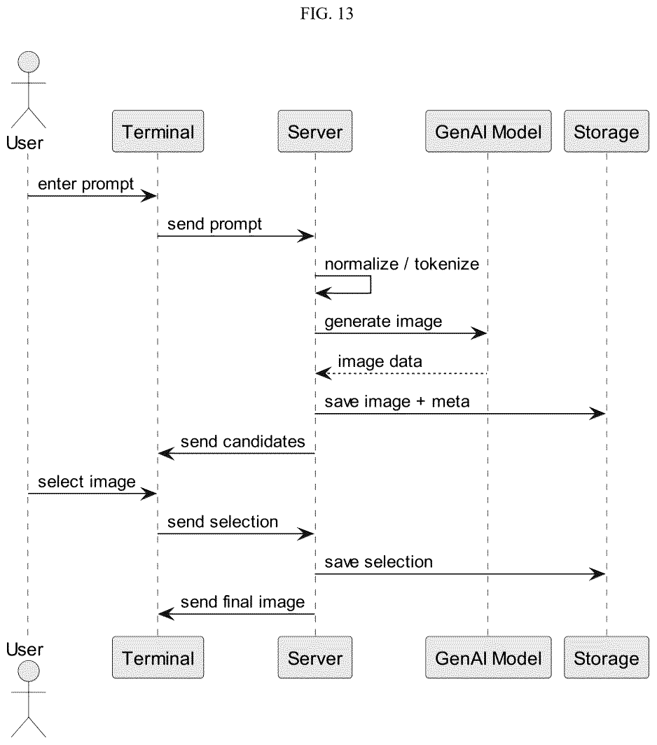

The following describes the processing flow using FIG. 13.

### Step 1

The user operates the terminal to input a prompt sentence.

The user views an input screen on the terminal, selects a text field, and types a prompt sentence such as “Summer campaign visual for our beverage brand using our official character, refreshing blue and green colors, character smiling and holding a cold drink, space on top for slogan text.”

Input: Raw keystrokes and touch events from the user.

Processing: The terminal's local processor converts the keystrokes into a character string and temporarily stores the string in a text buffer managed by a browser or application.

Output: A completed text string representing the prompt sentence displayed in the input field.

### Step 2

The terminal validates and formats the prompt sentence.

The terminal executes validation logic implemented in a script or native code to check that the prompt sentence is not empty and does not exceed a predetermined maximum length. The terminal trims leading and trailing spaces and replaces any unsupported control characters with safe placeholders.

Input: The text string representing the prompt sentence from Step 1.

Processing: The terminal applies string operations, including length computation, whitespace trimming, and character substitution, and then constructs a data object that holds the cleaned prompt sentence and optional parameters such as target usage and desired image size.

Output: A structured data object containing a cleaned prompt sentence and associated generation parameters.

### Step 3

The terminal transmits the formatted prompt sentence to the server.

The terminal uses its network interface to open an HTTPS connection to the server and sends a request containing the structured data object. The terminal sets communication headers and encodes the data object into a byte sequence using a character encoding such as UTF-8.

Input: The structured data object from Step 2 and network configuration data.

Processing: The terminal serializes the data object, encapsulates it in a communication protocol frame, and issues a transmission instruction through the operating system's networking stack.

Output: A network packet stream carrying the prompt sentence and parameters to the server.

### Step 4

The server receives and parses the transmitted request.

The server accepts the HTTPS connection, reads the incoming byte stream, and decodes it into a text-based representation. The server parses the text representation to reconstruct the structured data object.

Input: The network packet stream from Step 3.

Processing: The server's processor performs protocol-level parsing, decodes the byte stream using UTF-8, and applies a parser to convert the text into an internal data structure such as a dictionary or record, from which the server extracts the prompt sentence and associated parameters.

Output: An internal representation of the prompt sentence and generation parameters ready for further processing.

### Step 5

The server normalizes the prompt sentence.

The server applies natural language processing functions to standardize the prompt sentence. The server converts characters to a unified case, removes redundant spaces, and optionally appends guidance phrases describing layout requirements, character emphasis, or brand conformity.

Input: The internal representation of the prompt sentence from Step 4.

Processing: The server performs string normalization, concatenation of additional instruction phrases, and may apply simple linguistic analysis to detect keywords such as “summer,” “sports,” or “packaging” to decide which auxiliary phrases to add.

Output: A normalized prompt sentence that incorporates original user intent and system-level guidance for the generative AI model.

### Step 6

The server tokenizes the normalized prompt sentence for the generative AI model.

The server invokes a tokenizer module to split the normalized prompt sentence into subword tokens and map each token to an integer identifier according to a predefined vocabulary. The server also generates an attention mask to indicate which positions contain valid tokens.

Input: The normalized prompt sentence from Step 5.

Processing: The server applies tokenization algorithms, performs lookups in a vocabulary table stored in memory, and assembles arrays of token identifiers and corresponding mask values.

Output: A set of model input arrays including token identifier sequences and attention masks.

### Step 7

The server prepares generation parameters for the generative AI model.

The server determines numerical parameters such as image resolution, number of inference steps, guidance strength, and number of candidate images based on the prompt sentence, brand guideline information, and system configuration. The server may adjust these parameters if the prompt sentence indicates a complex layout or a need for higher detail.

Input: The tokenized data from Step 6 and context data including brand guidelines and user preferences.

Processing: The server maps high-level preferences to numeric values, for example selecting a resolution of 1024×1024 pixels, 50 denoising steps, and a guidance strength value within a preset range, and then packages these values into a parameter object associated with the token arrays.

Output: A complete model input structure containing token data and generation parameters.

### Step 8

The server executes the generative AI model to create visual representation candidates.

The server passes the model input structure to a generative AI model, which includes a text encoder and a denoising network. The server uses processor and accelerator resources to perform matrix multiplications, attention operations, and iterative denoising according to the model architecture.

Input: The model input structure from Step 7.

Processing: The server executes the text encoder to transform the token identifier sequence into embedding vectors, then initializes a noisy image representation and applies the denoising network repeatedly, each iteration updating the image representation based on the textual embeddings and noise estimates until the noise level is reduced below a target threshold.

Output: One or more high-dimensional arrays representing pixel data for visual representations that include the specific character and specified composition.

### Step 9

The server post-processes the generated image data.

The server converts the high-dimensional arrays into standard image formats. The server applies scaling, clipping, and color space conversion if necessary and encodes each image into a compressed file format suitable for storage and transmission.

Input: The pixel data arrays from Step 8.

Processing: The server performs numeric scaling of pixel values into a fixed range, transforms color channels to a target color space, and encodes the processed arrays using an image codec algorithm.

Output: Encoded image files representing visual representation candidates.

### Step 10

The server stores the generated images and metadata in an information processing apparatus. The server writes the encoded image files to a storage resource such as an object store and registers metadata in a database. The metadata links each image to the originating prompt sentence, generation parameters, brand constraints, and license condition information.

Input: The encoded image files and associated parameter data from Steps 7 and 9.

Processing: The server assigns unique identifiers to each image, issues storage write operations to persist the files, and executes database insert operations to store structured metadata records that reference the file locations and associated attributes.

Output: Persistent image records and metadata entries accessible through identifier-based queries.

### Step 11

The server generates response data for the terminal containing visual representation candidates.

The server selects a subset of the stored images as candidates to present to the user, retrieves thumbnail versions or generates reduced-size previews, and assembles a response object that includes candidate identifiers, image preview data, and descriptive fields.

Input: The persistent records from Step 10 and request context specifying which results are needed.

Processing: The server queries the database for images associated with the current prompt sentence or session, optionally filters candidates using brand constraints, and compresses previews for efficient network transmission.

Output: A structured response object containing visual representation candidate data addressed to the terminal.

### Step 12

The terminal receives and displays the visual representation candidates.

The terminal decodes the response data from the server, stores the previews temporarily in local memory, and renders them on the display as selectable images. The terminal labels each candidate with a selectable control to allow the user to indicate a choice.

Input: The structured response object from Step 11.

Processing: The terminal parses the object, extracts preview data and identifiers, and invokes graphics routines to draw the thumbnails and user interface elements on the screen.

Output: A visible arrangement of candidate images and selection controls on the terminal display.

### Step 13

The user reviews and selects one or more preferred visual representation candidates.

The user observes the previews on the display, evaluates their suitability for the intended campaign, and performs a selection action such as tapping or clicking on a preferred candidate.

Input: The rendered previews and selection controls from Step 12.

Processing: The user makes a cognitive judgment and performs a physical interaction that is captured by the terminal as input events.

Output: One or more selection events representing the user's choice of candidates.

### Step 14

The terminal encodes and transmits the selection data to the server.

The terminal collects the selection events, identifies the corresponding candidate identifiers, and constructs selection data that indicates which images have been chosen and any associated feedback ratings. The terminal sends this selection data to the server via the network.

Input: The selection events from Step 13 and candidate identifiers displayed on the terminal.

Processing: The terminal maps user interaction coordinates to candidate identifiers, packages the data into a structured format, and transmits the data using the same or a new HTTPS request.

Output: A network packet stream containing structured selection data sent to the server.

### Step 15

The server receives the selection data and records user selection as structured selection data. The server parses the incoming data, extracts identifiers of the selected candidates, and writes selection records into the database. Each record links a selected image to the originating prompt sentence, user identifier, and selection time.

Input: The network packet stream containing selection data from Step 14.

Processing: The server decodes the packet, reconstructs the selection data structure, and executes database operations to insert or update entries in a selection history table.

Output: Persistent structured selection records associated with generated images.

### Step 16

The server optionally adapts subsequent generation behavior based on selection data and emotion analysis.

The server analyzes the selection history and any provided textual feedback to estimate user satisfaction or emotional state. Using an emotion analysis engine, the server computes emotional scores and maps them to adjustments of future prompt sentences and generation parameters.

Input: The structured selection records from Step 15 and any feedback text received from the terminal.

Processing: The server applies a sentiment classification algorithm to the feedback text, evaluates patterns in selection frequency and rejection, and uses rule-based logic to alter keyword emphasis, add or remove descriptive phrases, or change configuration values such as style strength or color emphasis in subsequent model input.

Output: Updated rules and parameter settings that influence how future prompt sentences are normalized and how generative AI model parameters are set.

### Step 17

The server provides final image data and layout information for downstream design work. The server identifies the selected candidate image, retrieves its full-resolution file and associated metadata, and, if template layouts are used, calculates placement coordinates for insertion into a layout. The server then sends the full-resolution image and optional layout configuration to the terminal or a design workstation.

Input: The selection records from Step 15 and stored image and template data from Step 10.

Processing: The server locates the image file, ensures it satisfies brand and license constraints, computes scaling and placement values if a template is used, and prepares data suitable for consumption by design editing software.

Output: Full-resolution visual representation data and, when applicable, layout configuration data delivered to the terminal or another client for final advertising or packaging design creation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content generation systems that utilize generative AI models typically treat user input text as a flat prompt and forward it directly to the model without structured analysis, systematic emotion handling, or integrated layout control. As a result, these systems often suffer from several technical problems in the field of computer technology. First, they provide unstable and non-repeatable generation behavior, because the mapping from unstructured user text to model input is opaque and not logged in a structured way, thereby making it difficult for a computing environment to reproduce or audit outputs. Second, they lack an internal mechanism in the computing pipeline to decompose user input into topic information and emotion information and to convert such information into machine-interpretable generation instruction information, leading to inefficient utilization of computational resources of the generative AI model and increased trial-and-error calls. Third, existing systems generally do not integrate automatic layout computation and interactive user editing into a single coordinated processing flow on the server side; instead, layout and editing are often performed manually or with external tools, which increases processing latency, network traffic, and inconsistency between generated content and final layout. Fourth, known systems typically do not maintain structured associations between prompt sentences, model identifiers, and generation history information. This absence of linkage within the computing system hinders effective caching, reuse, debugging, and compliance management of generated content in large-scale deployments. Fifth, when brand constraints or intellectual property license conditions must be satisfied, conventional approaches rely on ad-hoc manual prompt crafting by human operators, rather than on a programmatic mechanism in the processor that embeds brand identification information and usage conditions into the generation instruction information itself, which makes automated enforcement of brand and license policies within the system architecture difficult. Accordingly, there is a need for an improved computer-implemented system that systematically analyzes user text, constructs and manages structured prompt sentences, coordinates generative AI models with layout computation and interactive refinement, and records generation metadata in association with final outputs so as to enhance consistency, reproducibility, and efficiency of generative content processing.

The specific processing by the specific processing unit 290 of the data processing device 12 in Application Example 2 is realized by the following means.

The present invention provides a server comprising a processor configured to analyze input text data using natural language processing to extract topic information and emotion information from the input text data and to generate, at a component level, generation instruction information based on the topic information and the emotion information, to augment the generation instruction information by adding style information, color information, composition information, and usage-type information including at least one of advertisement usage and narrative usage so as to generate a prompt sentence that is inputtable to a generative AI model, to input the prompt sentence to the generative AI model to cause the generative AI model to generate visual content data including at least one character, to automatically arrange the visual content data into a plurality of regions based on frame arrangement information and layout information so as to generate configuration information including at least one of an advertisement layout and a narrative panel structure, to generate preview data based on the configuration information and the visual content data and to transmit the preview data to a terminal device, to update the visual content data and the configuration information based on selection operation information and edit operation information received from the terminal device and, when necessary, to generate a re-prompt sentence according to update content and to input the re-prompt sentence again to the generative AI model so as to generate corrected visual content data, to store and output the corrected visual content data and updated configuration information as final output data, and to record, during a generation process, the prompt sentence, identification information of the generative AI model used for generation, and generation history information in association with the final output data. This enables the computing system to transform unstructured user text into structured, emotion-aware prompt sentences, to coordinate generative AI inference with automated layout computation and interactive refinement, and to maintain machine-readable generation metadata, thereby improving reproducibility, consistency, and processing efficiency of generative visual content within the computer architecture.

The term “input text data” refers to character-based digital information received by the system from a user, including natural language sentences, phrases, or other textual expressions that describe a theme, intent, or content to be generated.

The term “natural language processing” refers to a set of computational techniques executed by the processor that analyze and interpret human language text, including at least one of tokenization, part-of-speech tagging, parsing, entity extraction, and semantic analysis.

The term “topic information” refers to structured data representing a main subject, theme, or scenario extracted from the input text data by natural language processing.

The term “emotion information” refers to structured data indicating an affective state or sentiment, such as joy, sadness, or anger, inferred from the input text data by an emotion analysis function.

The term “generation instruction information” refers to internal structured parameters and descriptors generated by the processor, based on topic information and emotion information, that specify desired characteristics of content to be produced by a generative AI model.

The term “component level” refers to a granularity of processing in which the generation instruction information is constructed from multiple distinct elements, such as style, color, composition, and usage type, rather than as a single unstructured string.

The term “style information” refers to data specifying a visual or artistic manner of depiction, such as illustration style, graphic style, or narrative tone, to be applied by the generative AI model.

The term “color information” refers to data specifying color-related parameters, such as brightness, saturation, palette, or dominant colors, to be reflected in generated visual content.

The term “composition information” refers to data specifying spatial arrangement characteristics, such as placement, balance, focus, or viewpoint, for visual elements within generated content.

The term “usage-type information” refers to data that designates an intended application context of generated content, including at least one of advertisement usage and narrative usage.

The term “advertisement usage” refers to an intended use of generated content as part of promotional or marketing materials, such as banners, posters, or digital ads.

The term “narrative usage” refers to an intended use of generated content as part of a story or sequence, such as a comic, storyboard, or illustrated narrative.

The term “prompt sentence” refers to a machine-readable textual instruction generated by the processor, which encodes generation instruction information and is provided as input to a generative AI model.

The term “generative AI model” refers to a computational model implementing generative algorithms, including at least one of image generation models and text generation models, that receives a prompt sentence and outputs new content data.

The term “visual content data” refers to digital data representing visual media generated by the generative AI model, including at least one of images, illustrations, frames, or other graphical elements, and optionally including one or more characters.

The term “character” refers to a depicted entity such as a person, creature, or symbolic figure represented in the visual content data.

The term “frame arrangement information” refers to data specifying how multiple visual content elements are divided or arranged into discrete regions or frames on a layout surface.

The term “layout information” refers to data defining the positions, sizes, and relationships of visual and textual elements on a canvas, page, or screen.

The term “configuration information” refers to data that describes a structured arrangement of visual and textual elements, including at least one of advertisement layouts, narrative panel structures, and other visual configurations.

The term “advertisement layout” refers to a specific configuration information that arranges visual content data, text elements, and branding elements for promotional or marketing purposes.

The term “narrative panel structure” refers to a configuration information describing the arrangement of multiple panels or frames that collectively form a narrative sequence.

The term “visual configuration” refers to any structured arrangement of visual elements, including but not limited to grids, collages, storyboards, and panel layouts.

The term “preview data” refers to data generated by the processor that visually represents intermediate or candidate results of content generation and layout, and is intended for display on a terminal device for user review.

The term “terminal device” refers to a user-operated computing apparatus, such as a client device, display device, or user interface device, that communicates with the server to send input and receive output.

The term “selection operation information” refers to data representing user actions that choose or approve specific visual content data or layout options displayed on the terminal device.

The term “edit operation information” refers to data representing user actions that modify visual content data or configuration information, including at least cropping, repositioning, color adjustment, or text editing.

The term “re-prompt sentence” refers to a revised prompt sentence generated by the processor based on update content from user operations, and input again to the generative AI model to modify or regenerate visual content data.

The term “corrected visual content data” refers to visual content data produced by the generative AI model in response to a re-prompt sentence, reflecting user-requested corrections or refinements.

The term “final output data” refers to data representing a completed version of content, including corrected visual content data and updated configuration information, which is stored and made available for end use.

The term “identification information of the generative AI model” refers to data that uniquely identifies a particular generative AI model instance, version, or configuration used to generate visual content data.

The term “generation history information” refers to data that records at least part of a generation process, including prompt sentences, model identifiers, timestamps, and intermediate or final outputs.

The term “brand identification information” refers to data specifying a brand entity, such as a brand name, logo descriptor, or brand-specific attribute, to be reflected in generated content.

The term “reference design information” refers to data representing design examples or constraints used as a basis for aligning generated content with predetermined brand or style requirements.

The term “style consistency information” refers to data specifying constraints or rules that enforce visual uniformity across multiple generated contents, such as consistent use of colors, shapes, or character depiction.

The term “brand guidelines” refers to rules and specifications that define a desired visual and stylistic representation of a brand, including at least color schemes, typography, logo usage, and character usage.

The term “intellectual property right management information” refers to data indicating ownership, protection, and permitted use of creative assets associated with generated content.

The term “license condition information” refers to data specifying terms and restrictions under which generated content is allowed to be used, distributed, or commercialized.

The term “usage license” refers to permission defined by license condition information that authorizes certain uses of generated content under specified conditions.

The term “agreement between business entities” refers to a contractual arrangement between two or more organizational entities establishing rights and obligations concerning the use, distribution, or commercialization of generated content.

The term “server” refers to a computing apparatus or computing system that includes the processor and executes the described analysis, generation, arrangement, update, recording, and management processes.

In one embodiment, a server implements the claimed system as a network-accessible content generation platform. The server includes at least one processor, a main memory, a non-volatile storage device, and a network interface. The processor may be a multi-core central processing unit, optionally combined with one or more graphics processing units to accelerate deep learning inference. The server executes an operating system such as a general-purpose server operating system and runs application software modules written in a high-level programming language.

The server uses a natural language processing library such as a general-purpose language analysis library to perform tokenization, part-of-speech tagging, dependency parsing, and named entity recognition. The server uses a deep learning framework such as a general-purpose tensor computation library to perform inference for a generative AI model on the GPU. The server uses a database management system such as a relational database engine to store prompt sentences, generation instruction information, model identifiers, and generation history information.

The terminal is a client device such as a smartphone, tablet, or personal computer that includes a processor, a memory, a display, and an input device. The terminal executes a client application or web browser and provides a graphical user interface to the user. The graphical user interface includes text input fields, preview areas, and controls for selecting and editing generated visual content.

The user operates the terminal and inputs free-form natural language text describing a desired theme, mood, or usage. The user may input, for example, “I need a joyful advertisement visual for a new running shoe, set in a summer sports festival.” The terminal transmits this text to the server in a structured format over a network using a communication protocol. The server receives the input text and stores it in the database together with a request identifier. The server applies natural language processing to the text to extract topic information and emotion information. The server uses symbolic features such as token sequences, part-of-speech tags, dependency relations, and entity tags to identify key phrases representing the subject (for example, “running shoe,” “summer sports festival”) and affective expressions (for example, “joyful,” “exciting”).

The server additionally uses an emotion analysis engine, which may be implemented as a neural network classifier trained on labeled sentiment data. The neural network may have an architecture including an embedding layer, a recurrent or transformer encoder, and a classification head that outputs a probability distribution over emotion categories such as joy, sadness, anger, surprise, or calmness. The server provides the tokenized text as input to this network and receives emotion scores as output. The server converts these scores into emotion information suitable for subsequent processing, for example by selecting the highest-probability category and normalizing its confidence.

The server converts the extracted topic information and emotion information into generation instruction information. In one embodiment, the server represents generation instruction information as a structured object composed of multiple fields, including style information, color information, composition information, and usage-type information. For example, style information may indicate that the content is “manga-style character illustration”; color information may indicate “bright, high-saturation palette”; composition information may indicate “dynamic diagonal layout with motion emphasis”; usage-type information may indicate “advertisement layout for digital banner.”

The server maps emotion information to visual parameters using a rule-based mapping table stored in the database. For example, the server may map “joy” to a high brightness parameter, warm color temperature, and high saturation, whereas “sadness” is mapped to low brightness, cool color temperature, and desaturated colors. These mappings are computed algorithmically by the processor rather than manually, and they influence subsequent model parameters and prompt sentence construction. This mapping is specific to the system and provides a non-standard way of embedding emotion into model instructions, which differs from a human simply describing mood in prose.

The server constructs a prompt sentence from the generation instruction information. The server uses a template-based prompt generator, in which slots for style, subject, emotion-based modifiers, composition descriptors, and usage constraints are filled according to the structured data. In some embodiments, the server uses an auxiliary text generation model to refine word choice. The prompt sentence for the above example may be:

“Generate a bright, joyful illustration for a running shoe advertisement at a summer sports festival, with dynamic characters running in a manga style, vivid colors, and clear space at the top for a slogan.”

In another example, when the user requests narrative content, the prompt sentence may be: “Draw a shonen-manga style hero battling a villain at sunset, with dramatic lighting and dynamic panel layout, expressing determination and excitement.”

In yet another example, when the user's text indicates sadness, the prompt sentence may be: “Create a dark-toned character illustration that expresses sadness, in a manga style, with a rainy city background.”

The server transmits the prompt sentence to a generative AI model. In one embodiment, the generative AI model is an image-generating diffusion model implemented using a deep neural network with a U-Net backbone and a transformer-based text encoder. The text encoder converts the prompt sentence into a sequence of embeddings. The diffusion model performs iterative denoising on a latent representation over a fixed number of steps, where each step uses cross-attention between the latent representation and the text embeddings. The server controls the number of diffusion steps, guidance scale, and random seed as explicit parameters, which affect generation time and output variability.

The server runs this generative AI model on a GPU using the deep learning framework to accelerate matrix multiplications, convolution operations, and attention mechanisms. This hardware-accelerated inference results in significantly faster generation compared to CPU-only processing, thereby reducing system latency for interactive use. The server receives the generated latent representation from the diffusion model, decodes it into pixel data using a decoder network, and converts it into an image file format suitable for transmission and display.

The server records the prompt sentence, the model configuration (including model version, parameter counts, and specific checkpoint identifier), and runtime parameters such as the seed and guidance scale in a generation history record associated with the output image. This structured association enables the server to reproduce a particular output by re-running the same model configuration with identical parameters, which is generally not feasible when a human user manually interacts with a generative AI model.

The server additionally performs layout computation on the generated visual content data. In one embodiment, the server represents a layout as a data structure containing a list of frames, where each frame has coordinates (x, y), width, height, and z-order, plus references to one or more visual content items and text elements. The server uses deterministic algorithms to compute frame sizes and positions based on usage-type information and target aspect ratio. For example, an advertisement layout may reserve a top strip for a headline, while a narrative layout may use a three-panel vertical sequence.

The server maps each generated image to one or more frames according to this configuration information. The server can also generate text elements, such as taglines or captions, using a text generative model that converts the topic information and emotion information into short sentences. For example, for the running shoe advertisement, the server may generate the slogan “Run into the joy of summer,” and place it in the reserved headline region, thus enforcing a technical link between model output and layout metadata.

The server merges visual content data, layout coordinates, and text into preview data. In one embodiment, the server uses an image processing library to render a preview bitmap by drawing each frame region and its assigned content onto a canvas. The generated preview has a specified resolution, which may be lower than the final output resolution to reduce bandwidth and improve responsiveness. The server transmits this preview data to the terminal.

The terminal displays the preview image on the display panel and presents interface controls for selection and editing. The user may tap on a frame to select a particular candidate illustration, drag to rearrange panels, or modify text fields. The user may also change color intensity or cropping regions through dedicated sliders or handles in the interface.

The terminal encodes these user operations as selection operation information and edit operation information, which include identifiers of frames, image references, numeric parameters (such as crop coordinates or color adjustment factors), and modified text strings. The terminal transmits these operation data to the server.

The server interprets the user operations and updates the configuration information and visual content data accordingly. If the user changes only the layout, the server updates frame coordinates and recalculates the rendered preview without invoking the generative AI model. This reduces unnecessary computation and network traffic, thereby improving overall system efficiency.

If the user requests semantic changes, such as altering the character's clothing color or mood, the server generates a re-prompt sentence based on the current generation instruction information and the new user constraints. For example, if the user requests that the main character's outfit be changed from blue to red, the server may generate:

“Modify the existing illustration by changing the main character's outfit to red, while keeping the joyful summer sports festival atmosphere and the running shoe advertisement focus.”

The server may supply the original image and a mask defining the region to be modified to an inpainting variant of the diffusion model. The model then performs conditional sampling within the masked region while being constrained by the prompt sentence and the unmodified context. The server again records this re-prompt sentence and associated model parameters in the generation history information.

In some embodiments, the server also enforces brand guidelines using structured brand identification information, reference design information, and style consistency information stored in the database. The server merges these constraints into the generation instruction information so that the prompt sentence explicitly encodes brand-specific attributes, such as required color schemes or character features. This automated integration of brand constraints into prompt sentences reduces the risk of non-compliant output and avoids reliance on manual checking.

In further embodiments, the server associates intellectual property right management information and license condition information with each generation request and resulting output. When the server exports final output data, it includes corresponding metadata indicating permitted use and required attributions, enabling downstream systems to enforce licensing constraints programmatically.

The server stores the final output data with high resolution and, optionally, multiple format variants. Because the server has maintained complete generation history information, including prompt sentences and model identifiers, the server can later regenerate similar or derived content reliably by reusing or adapting the recorded generation instruction information. This reproducibility is a technical improvement over ad-hoc manual prompting and leads to more efficient and predictable use of computing resources in large-scale deployments.

From a computer technology perspective, the described architecture improves processing efficiency, reproducibility, and output quality in several ways. The structured conversion from input text to generation instruction information and then to prompt sentences reduces variability and unnecessary trial-and-error interactions with the generative AI model, thereby decreasing compute usage and latency. The emotion-to-parameter mapping table provides a deterministic, machine-controlled way of encoding affect into visual parameters, reducing uncertainty compared to free-form textual descriptions. The separation of layout computation from content generation allows the server to reuse generated images across different layouts without re-invoking the generative AI model, thereby reducing GPU load.

The modular design of the server, in which separate components perform natural language processing, emotion analysis, prompt sentence generation, diffusion model inference, layout computation, preview rendering, and metadata recording, enables optimized data flow and concurrent processing. For example, while the diffusion model generates images, the server may already compute candidate layouts using pre-known templates. This pipelining reduces overall response time and leverages the parallel capabilities of the underlying hardware.

The neural network models used for emotion analysis and image generation are trained using supervised or self-supervised learning. During training, the server or a training environment minimizes a loss function such as cross-entropy for emotion classification or a denoising loss for diffusion. The models update their weights using gradient-based optimization, such as stochastic gradient descent or adaptive methods. Training data may be augmented by techniques such as random cropping, color jittering, and text paraphrasing to improve model robustness. Although training is performed offline, the resulting models, when deployed, enable the server to make consistent and high-quality inferences at runtime.

Because the server records model identifiers and generation parameters with each output, the system can implement caching strategies and precomputation for frequently used prompts. When a new request is similar to a past request, the server can retrieve prior results or optimize parameters based on previous performance, thereby improving both computational efficiency and output stability.

The described system is not limited to advertisement content. The same architecture can be applied to narrative comics, educational visualizations, product packaging designs, or other visual media. In each case, the server processes input text, converts it into structured generation instruction information, constructs prompt sentences, invokes appropriate generative AI models, and computes layout structures suitable for the target medium.

In a variant embodiment, the server may support multiple generative AI models in parallel, including image generation models and text generation models. The server selects a model dynamically based on usage-type information and requested resolution or style. The server may also integrate additional modules such as vectorization engines for converting raster images into scalable graphics or font selection engines for matching text style to the generated imagery.

In another embodiment, the server may operate in a distributed computing environment, with the generative AI model hosted on a separate inference node. The core architecture remains the same: the main server constructs and manages prompt sentences and generation history information, while the inference node focuses on performing heavy numerical computations. This separation allows scalable deployment while preserving the technical benefits of structured prompt management and layout integration.

Through these embodiments, the server, the terminal, and the user cooperate in a manner that improves the behavior of the computing system itself rather than merely automating human artistic tasks. The system's structured generation instruction information, emotion-aware mapping, reproducible prompt sentences, and integrated layout computation contribute to reductions in processing time, more consistent outputs, improved data management, and better utilization of computational resources, thereby achieving a concrete technological improvement in computer-based generative content processing.

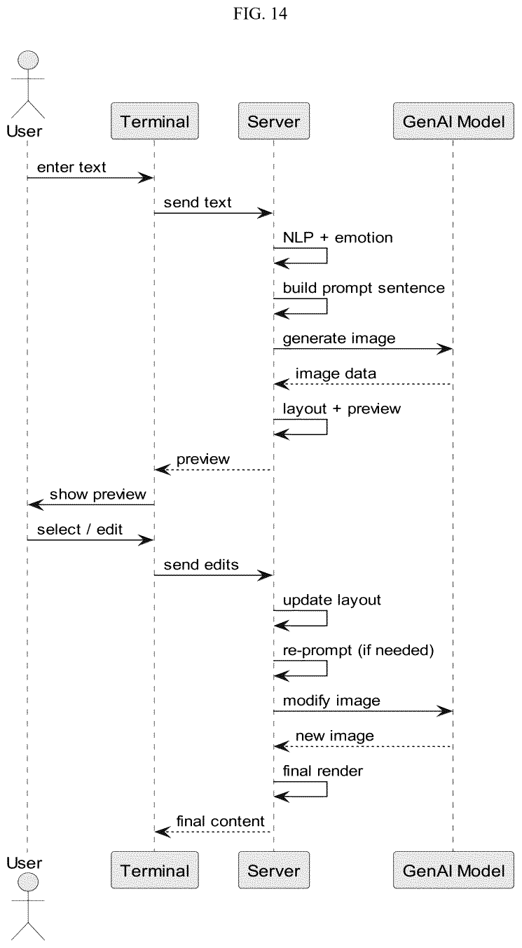

The following describes the processing flow using FIG. 14.

### Step 1

User operates the terminal and inputs natural language text describing a desired theme, emotion, or usage.

User provides, as input, a text string such as “I need a joyful advertisement visual for a new running shoe, set in a summer sports festival.”

Terminal receives this text, stores it as UTF-8 encoded data in working memory, and associates it with a newly created request identifier and basic metadata (time stamp, user ID). Terminal outputs a structured request object containing at least the text string and the request identifier for transmission to the server.

### Step 2

Terminal sends the structured request object to the server over a network using a communication protocol.

Terminal takes, as input, the request object from Step 1, serializes it into a message (for example, a JSON payload) and issues an HTTP request to a designated server endpoint.

Terminal outputs a network message containing the user text, request identifier, and optional parameters such as desired output type or resolution.

Server receives the network message, parses the payload, and validates the content.

Server takes, as input, the serialized request, decodes the message, and extracts the text string, request identifier, and options.

Server outputs a normalized internal data record stored in a database, including the input text and associated metadata.

### Step 3

Server performs natural language processing on the input text to extract topic information. Server takes, as input, the text string from the internal data record, and applies a language analysis library to perform tokenization, part-of-speech tagging, and dependency parsing. Server computes keyword scores by aggregating token frequency, syntactic role, and position information, then identifies phrases corresponding to subject entities and scenarios, such as “running shoe” and “summer sports festival.”

Server outputs topic information as a structured set of fields including subject terms, scene descriptors, and usage hints, and stores this in the internal record.

### Step 4

Server performs emotion analysis on the input text to obtain emotion information.

Server takes, as input, the same text string and forwards tokenized text to an emotion classification module implemented as a neural network or rule-based engine.

Server applies the classifier to compute a probability distribution over emotion labels (for example, joy, sadness, anger) and selects the dominant label and confidence value.

Server maps the detected emotion to normalized emotion information (for example, emotion=joy, intensity=high) and writes this emotion information to the internal record as output.

### Step 5

Server converts topic information and emotion information into generation instruction information at a component level.

Server takes, as input, the topic information and emotion information from the previous steps and combines them with system defaults such as target medium (advertisement, narrative) and style preferences.

Server performs data processing to populate multiple fields: style information (for example, “manga-style illustration”), color information (for example, “bright, warm, high saturation”), composition information (for example, “dynamic diagonal layout”), and usage-type information (for example, “advertisement banner”). This includes rule-based mapping from emotion to color and composition parameters.

Server outputs generation instruction information as a structured object with multiple components and stores it in association with the request identifier.

### Step 6

Server generates a prompt sentence for a generative AI model based on the generation instruction information.

Server takes, as input, the structured generation instruction information, including style, color, composition, and usage type, and applies a template-based text generator.

Server concatenates fixed phrases and variable segments, converts numerical parameters (for example, brightness level) into descriptive adjectives (for example, “bright”), and arranges them into a coherent natural language instruction.

Server outputs a prompt sentence, such as “Generate a bright, joyful illustration for a running shoe advertisement at a summer sports festival, with dynamic characters running in a manga style, vivid colors, and clear space at the top for a slogan,” and stores this sentence as part of the generation history for the request.

### Step 7

Server selects and configures an appropriate generative AI model and sends the prompt sentence to the model.

Server takes, as input, the prompt sentence and request parameters (for example, desired resolution, number of candidates) and chooses a particular generative AI model type such as an image diffusion model.

Server loads or references the model configuration, sets inference parameters (for example, number of denoising steps, guidance scale, random seed), and packages the prompt sentence and parameters into a model input structure.

Server executes the generative AI model using a deep learning framework on a processor or accelerator, which performs tensor operations and iterative denoising conditioned on the prompt sentence.

Server outputs one or more visual content data items (for example, images in an in-memory representation) as the raw model result.

### Step 8

Server converts the model output into visual content data files and records generation history. Server takes, as input, the visual content data from the model and associated inference parameters.

Server applies image post-processing such as normalization, color space conversion, and compression, and encodes the result into standard image formats (for example, PNG, JPEG). Server outputs file paths or binary blobs for the generated images and persists them in storage. Simultaneously, the server records the prompt sentence, selected model identifier, inference parameters, and output references as generation history information linked to the request identifier.

### Step 9

Server computes configuration information to arrange visual content data into a layout or panel structure.

Server takes, as input, the visual content data references and usage-type information from generation instruction information.

Server executes a layout algorithm that computes a set of frames with coordinates and sizes based on target aspect ratio, required number of panels, and reserved regions for text. For example, for an advertisement layout, the server reserves a top area for a headline and positions the main image centrally.

Server assigns each generated image to a frame, optionally selecting the best image candidate based on simple heuristics (for example, aspect ratio similarity or color balance).

Server outputs configuration information describing frame geometry, assigned content references, and any preliminary text placeholders, and stores it with the request identifier.

### Step 10

Server generates preview data for display on the terminal.

Server takes, as input, the configuration information and the stored image files.

Server uses an image composition module to render a preview canvas by drawing each frame at its specified coordinates and overlaying placeholder or generated text. The server may reduce image resolution to create a lighter preview.

Server outputs a preview image or related representation and constructs a response payload containing preview data, image identifiers, frame metadata, and the prompt sentence. The server then transmits this payload to the terminal.

### Step 11

Terminal receives the preview data and displays it to the user.

Terminal takes, as input, the response payload from the server, parses the metadata, and retrieves the preview image and any supplementary images or text.

Terminal renders the preview on the display, positioning selectable regions and overlaying controls such as buttons or handles for editing. Terminal may maintain a local mapping from visible elements to their corresponding image IDs and frame IDs.

Terminal outputs a visual presentation of the generated content and internal state ready to capture user interactions.

### Step 12

User reviews the preview and performs selection and editing operations on the terminal. User takes, as input, the rendered preview and uses input devices such as touch or pointing devices to select specific images, frames, or text elements.

User may, for example, choose one of multiple candidate images, move a panel, change a text string, adjust color intensity, or request a different outfit color for a character.

Terminal captures these actions as selection operation information and edit operation information, including identifiers (image ID, frame ID), updated numeric parameters (for example, crop coordinates, color adjustments), and new text content.

Terminal outputs a set of operation instructions encoded in a structured format for transmission to the server.

### Step 13

Terminal sends the selection operation information and edit operation information to the server.

Terminal takes, as input, the locally recorded user operations and bundles them into an update request associated with the original request identifier.

Terminal transmits this update request over the network to the server.

Terminal outputs a network message that precisely describes which elements were selected, how they were edited, and what new constraints should be applied.

### Step 14

Server updates configuration information and visual content data based on user operations and, when necessary, generates a re-prompt sentence for corrective content generation. Server takes, as input, the update request from the terminal, retrieves the corresponding configuration information and visual content references, and interprets each operation. Server applies direct layout operations (such as moving frames or cropping images) by recalculating frame coordinates or cropping rectangles and updating the configuration information. These operations use geometric computations based on frame dimensions and canvas size.

If an operation requires semantic modification (for example, change character outfit color or mood), the server updates the generation instruction information by altering specific fields (for example, color information or emotion-derived attributes), and then constructs a re-prompt sentence that reflects the new constraints.

Server outputs updated configuration information and, if applicable, a new re-prompt sentence, storing both with the request identifier.

### Step 15

Server performs corrective generation using the re-prompt sentence and updates the visual content data.

Server takes, as input, the re-prompt sentence and any additional data such as the original image and a mask defining a region to be modified.

Server invokes the generative AI model in a modification or inpainting mode, using the re-prompt sentence as conditioning information and the provided mask to restrict changes to specific regions. The model executes a sequence of tensor operations to recompute pixel values within the masked region while preserving context outside the mask.

Server outputs corrected visual content data, encodes it as updated image files, and replaces or augments the previous image references in storage and in the configuration information.

### Step 16

Server generates a refreshed preview and, once approved by the user, finalizes and stores the final output data.

Server takes, as input, the updated configuration information and corrected visual content data from Step 15.

Server re-renders the layout into a new preview image and transmits it to the terminal for confirmation. After the user indicates approval (via a separate signal, not detailed here), the server generates high-resolution final output data by rendering the layout at full resolution and encoding files in appropriate delivery formats such as high-quality image or document formats.

Server outputs the final output data files and updates generation history information to indicate completion, maintaining associations among the original prompt sentence, any re-prompt sentences, model identifiers, and final assets.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

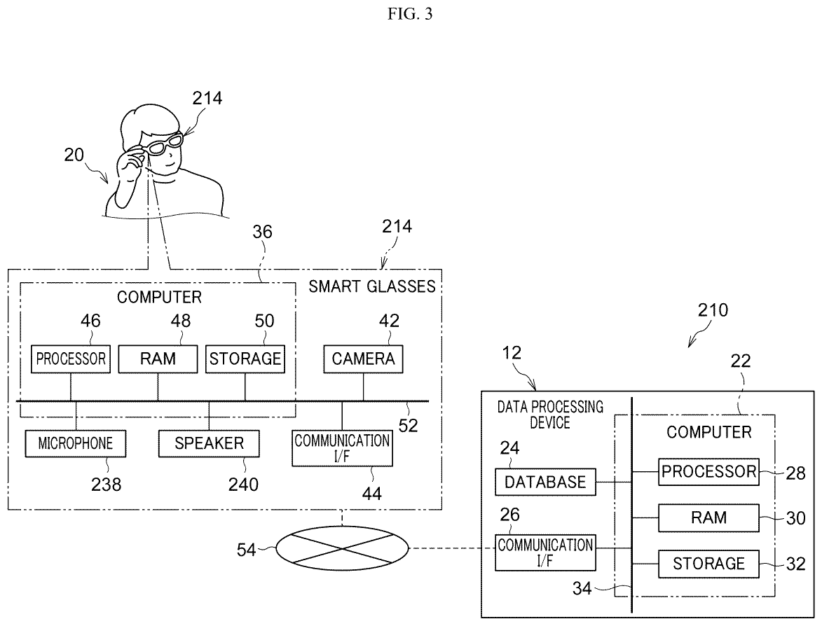

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

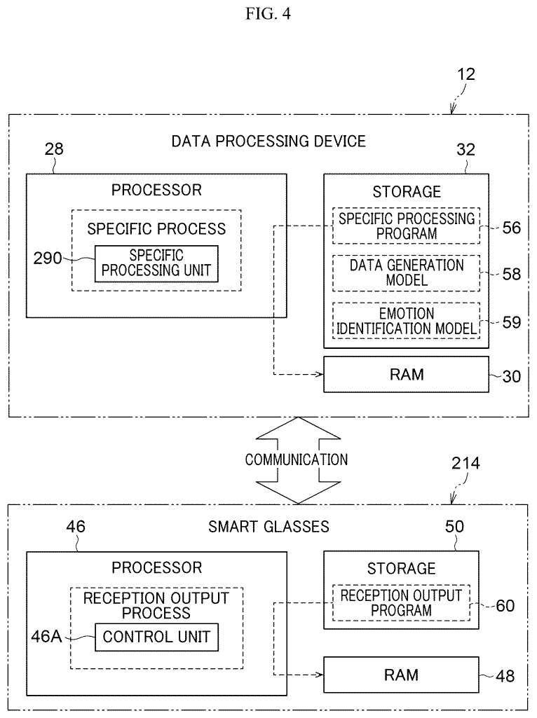

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

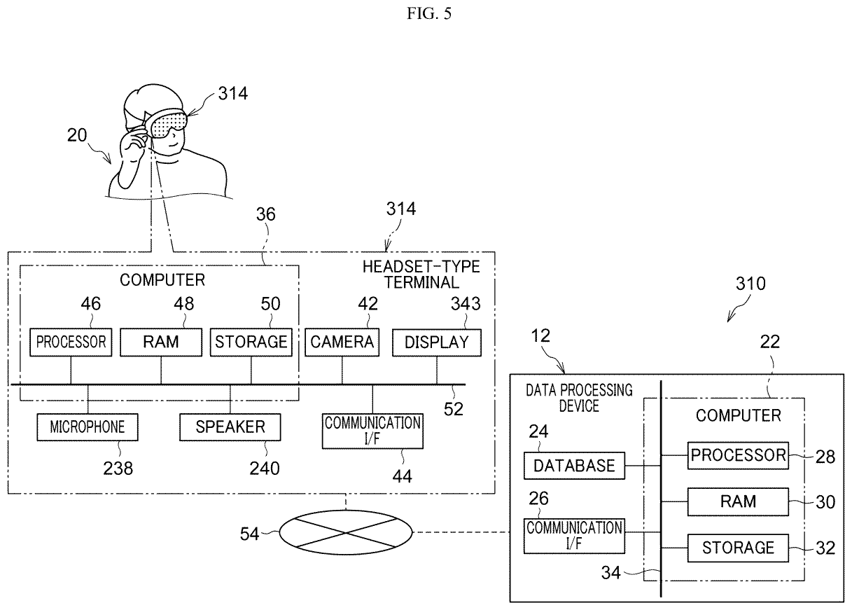

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

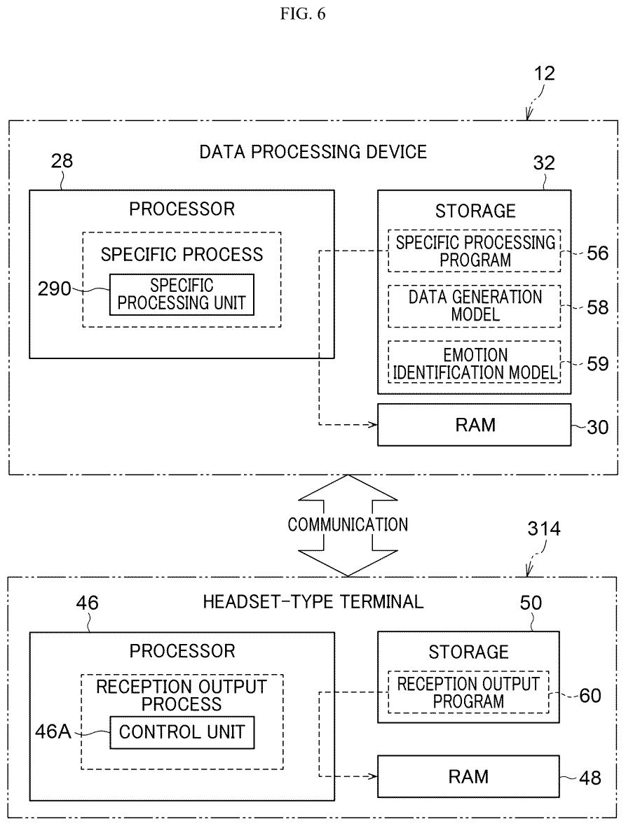

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

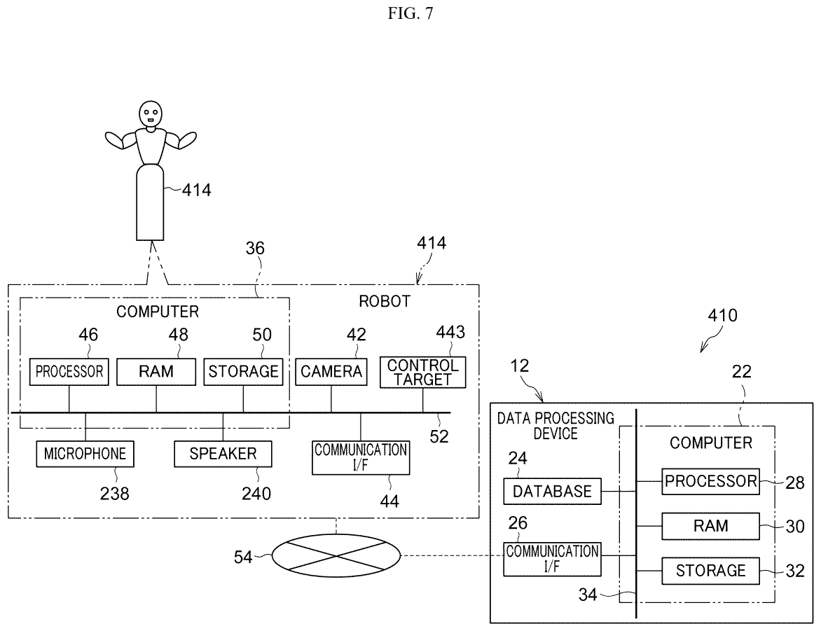

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

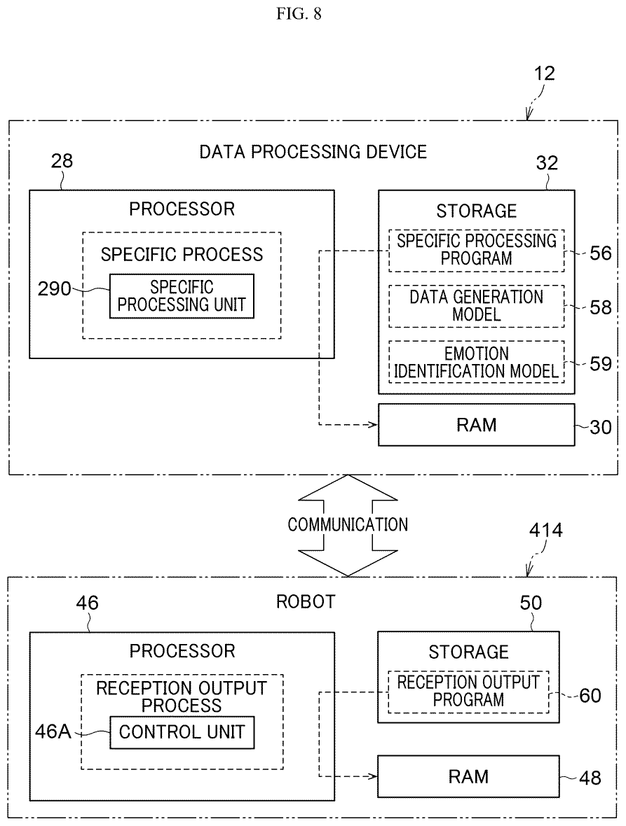

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

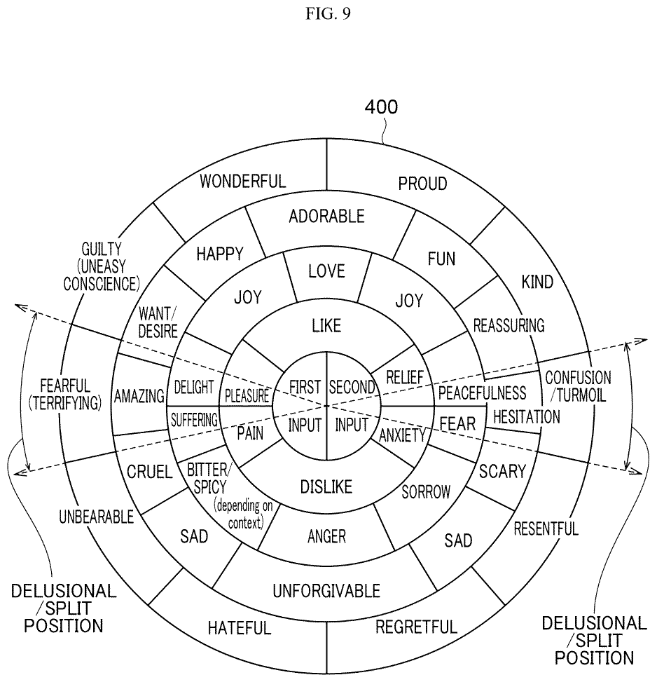

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

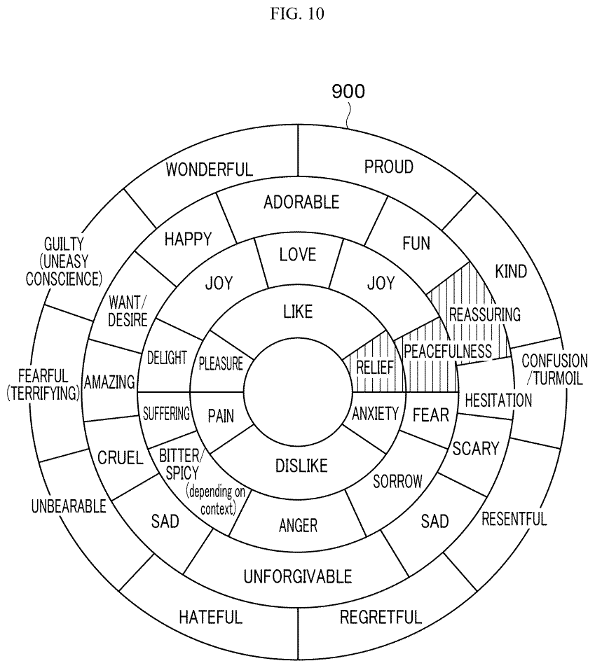

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive language data input by a user via a terminal, analyze the language data by using a natural language processing algorithm, and extract structured information including at least a subject, key terms, an expression style, and a use purpose,
automatically generate, on a server, a prompt sentence for input to a generative AI model for image generation based on the structured information, and cause the generative AI model to generate visual data according to the prompt sentence,
automatically determine, on the server, layout information including at least a page size, panel arrangement, and panel order based on the visual data and the structured information, and automatically generate a content page including a plurality of panels by arranging the visual data according to the layout information,
acquire, via the terminal, additional language data including instructions from the user regarding the content page or a generation process thereof, analyze, on the server, the additional language data to update the structured information, regenerate at least one of the prompt sentence and the visual data based on the updated structured information, and reconstruct at least a part of the layout information and at least a part of the content page according to a result of the regeneration,
analyze emotion information related to the user by using an emotion analysis algorithm, and correct at least one of the prompt sentence and the layout information such that an expression style and a structure conform to the emotion information, and
generate output data of the content page in at least one of an image format and a document format, and transmit the output data to the terminal so as to enable display or storage of the output data.

### Supplementary 2

The system according to supplementary 1,
wherein the processor is configured to
store brand-related information including brand identification information and expression rules, and automatically adjust at least one of appearance attributes of an appearance target in the structured information, the prompt sentence, and the layout information such that the appearance attributes conform to the brand-related information.

### Supplementary 3

The system according to supplementary 1,
wherein the processor is configured to
refer to use condition information related to rights-target data, control at least one of generation and an output form of the visual data and the content page based on the use condition information, and manage the content page in a form commercially usable in accordance with a utilization permission agreement with a third party.

### Application Example 1

### Supplementary 1

A system comprising a processor,
wherein the processor is configured to
analyze input character information by using natural language processing technology to extract subject information and attribute information related to an advertisement, and automatically generate a prompt sentence, by using a generative information processing model, for causing generation of a visual expression having a specific style on the basis of the subject information and the attribute information, and
convert the prompt sentence from character information into feature data, input the feature data as a condition to an image generation generative information processing model, and
generate a visual expression image having the specific style, and
detect a main target region included in the visual expression image by using image processing technology, determine a page-level frame arrangement structure on the basis of the main target region, and automatically generate panel division by allocating a plurality of visual expression images according to the frame arrangement structure, and
synthesize the visual expression images on a page canvas according to the panel division, and
superimpose character information including at least advertisement information on the page canvas to generate advertisement content in a comic format, and
transmit the generated advertisement content to a user terminal via a communication device, and cause the user terminal to display the advertisement content, and
analyze a user emotion by using an emotion analysis information processing engine, and, on the basis of an analysis result, automatically generate, additionally or update-wise, a prompt sentence for causing the generative information processing model to generate a visual expression image and panel division adapted to the emotion.

### Supplementary 2

The system according to supplementary 1,
wherein the processor is configured to
use, in the generation of the prompt sentence and the generation of the visual expression image, a generative information processing model that has learned expression features relating to a specific creative style, and cause the visual expression image and the panel division to conform to the expression features.

### Supplementary 3

The system according to supplementary 1,
wherein the processor is configured to
superimpose brand identification information and service identification information on the advertisement content in the comic format, convert the advertisement content into formats adapted to a plurality of distribution media, and store the advertisement content as outputtable data.

### Example 2

### Supplementary 1

A system comprising a processor,
wherein the processor is configured to
analyze input text information by using natural language processing to generate a prompt sentence for instructing a generative AI model to automatically generate a visual representation,
input the prompt sentence to the generative AI model and automatically generate, based on numerical computation processing by the generative AI model, a visual representation including a specific character and a composition of the visual representation,
store the automatically generated visual representation and the composition in a storage resource in an information processing apparatus as basic data for an advertising design or a packaging design,
generate the advertising design or the packaging design by using design editing software to automatically place the visual representation of the specific character into an advertising layout or a packaging layout on the basis of the stored visual representation and the composition,
transmit, from a terminal operated by a user, the prompt sentence input by the user to a server through a communication function, acquire, at the terminal, a plurality of visual representation candidates generated at the server, and accept a selection operation by the user for one of the plurality of visual representation candidates,
analyze an emotion of the user by using an emotion analysis engine, and dynamically change content of the prompt sentence or instruction parameters to the generative AI model according to an analysis result so that a visual representation and a composition suitable for the emotion of the user are generated,
apply brand constraint conditions including at least one of color tone, shape, and arrangement rules to the prompt sentence or to the generated visual representation and the composition so that the specific character is adapted to a brand guideline, and
manage the visual representation and the composition generated by the generative AI model in association with license condition information and accumulate the visual representation, the composition, and the license condition information in the information processing apparatus in preparation for commercial use in a wide range of applications.

### Supplementary 2

The system according to supplementary 1,
wherein the processor is configured to automatically supplement or transform the prompt sentence on the basis of attribute information for identifying the specific character and brand guideline information, and to adjust instruction content to the generative AI model so that a design of the specific character conforms to the brand guideline information.

### Supplementary 3

The system according to supplementary 1,
wherein the processor is configured to manage, assuming use by a joint business entity with a rights holder of intellectual property, the visual representation, the composition, and the license condition information stored in the information processing apparatus in an associated manner, and to enable commercial use of content generated by the generative AI model on the basis of the license condition information.

### Application Example 2

### Supplementary 1

A system comprising a processor,
wherein the processor is configured to
analyze input text data using natural language processing to extract topic information and emotion information from the text data, and generate, at a component level, generation instruction information based on the topic information and the emotion information, the generation instruction information being used for generation processing, and
augment the generation instruction information by adding style information, color information, composition information, and usage-type information including at least one of advertisement usage and narrative usage, thereby generating a prompt sentence that is inputtable to a generative AI model used for generation, and input the augmented prompt sentence to the generative AI model to cause the generative AI model to generate visual content data including at least one character, and
automatically arrange the visual content data into a plurality of regions based on frame arrangement information and layout information, thereby generating configuration information including at least one of an advertisement layout, a narrative panel structure, and
another visual configuration, and generate preview data based on the configuration information and the visual content data, and transmit the preview data to a terminal device, and
update the visual content data and the configuration information based on selection operation information and edit operation information received from the terminal device, and, when necessary, generate a re-prompt sentence according to update content and input the re-prompt sentence again to the generative AI model to generate corrected visual content data, and store and output the corrected visual content data and updated configuration information as final output data, and
record, during a generation process, the prompt sentence, identification information of the generative AI model used for generation, and generation history information, and manage the generation history information in association with the final output data.

### Supplementary 2

The system according to supplementary 1,
wherein the processor is configured to
embed brand identification information, reference design information, and style consistency information into the generation instruction information so that visual content data including a specific character conforms to predetermined brand guidelines by automatically adjusting the prompt sentence, and generate visual content data and configuration information that are aligned with the brand guidelines.

### Supplementary 3

The system according to supplementary 1,
wherein the processor is configured to
record intellectual property right management information and license condition information in association with the generation instruction information and the generation history information, and manage and provide the generated visual content data and the configuration information as output data commercially usable under a usage license based on an agreement between business entities.

What is claimed is:

1. A system comprising:
circuitry configured to:
receive, via a communication interface coupled to a packet-switched network, language data from a terminal device, analyze the language data using a natural language processing algorithm, and extract structured information comprising at least a subject, key terms, an expression style, and a use purpose;
generate a prompt sentence for a generative neural network model for image generation based on the structured information, transmit the prompt sentence to the generative neural network model via the communication interface, and obtain visual data generated by the generative neural network model according to the prompt sentence;
determine layout information comprising at least a page size, panel arrangement, and panel order based on the visual data and the structured information, and generate a content page comprising a plurality of panels by arranging the visual data according to the layout information;
receive additional language data comprising instructions from the terminal device via the communication interface, analyze the additional language data to update the structured information, regenerate at least one of the prompt sentence and the visual data based on the updated structured information, and reconstruct at least a part of the layout information and at least a part of the content page based on the regeneration result;
analyze emotion information associated with a user using an emotion analysis algorithm, and correct at least one of the prompt sentence and the layout information to conform an expression style and a structure to the emotion information; and
generate output data of the content page in at least one of an image format and a document format, and transmit the output data to the terminal device via the communication interface.

2. The system according to claim 1, wherein the circuitry is configured to store brand-related information comprising brand identification information and expression rules in a storage device, and to automatically adjust at least one of appearance attributes of an appearance target in the structured information, the prompt sentence, and the layout information to conform the appearance attributes to the brand-related information.

3. The system according to claim 2, wherein the circuitry is configured to apply a brand consistency validation function to the visual data generated by the generative neural network model to verify that the appearance attributes of the appearance target conform to the expression rules, and to regenerate the prompt sentence with additional brand constraint specifications when a violation is detected.

4. The system according to claim 2, wherein the circuitry is configured to store a plurality of brand-related information entries indexed by brand identification information in the storage device, and to select the applicable brand-related information based on a brand identifier extracted from the language data or the structured information.

5. The system according to claim 1, wherein the circuitry is configured to refer to use condition information associated with rights-target data stored in a storage device, control at least one of the generation and an output form of the visual data and the content page based on the use condition information, and manage the content page in a form usable in accordance with a utilization permission agreement.

6. The system according to claim 5, wherein the circuitry is configured to apply a rights compliance validation function to the structured information to identify appearance targets associated with the rights-target data, verify that the use purpose extracted from the structured information is permitted under the use condition information, and block generation of visual data when the use purpose is not permitted.

7. The system according to claim 5, wherein the circuitry is configured to log each generation event, the associated use condition information applied, and the output form in a storage device as rights management records, and to transmit the rights management records to an authorized terminal device upon request via the communication interface.

8. The system according to claim 1, wherein the circuitry is configured to apply a layout optimization function to the layout information to compute a visual balance score based on panel sizes and the spatial distribution of visual data within the content page, and to adjust the panel arrangement to increase the visual balance score prior to generating the content page.

9. The system according to claim 8, wherein the circuitry is configured to apply a semantic coherence function to the panel order to verify that the visual data in consecutive panels maintains a temporal or logical progression consistent with the structured information, and to reorder the panel arrangement when a coherence score falls below a threshold.

10. The system according to claim 8, wherein the circuitry is configured to generate a plurality of candidate layout configurations by varying the page size, panel arrangement, and panel order parameters, compute a visual balance score for each candidate, and select the candidate with the highest score as the layout information.

11. The system according to claim 1, wherein the circuitry is configured to apply a change detection function to the updated structured information to identify the subset of panels affected by the additional language data instructions, and to limit the regeneration of the prompt sentence and the visual data to the affected subset to reduce computational overhead.

12. The system according to claim 11, wherein the circuitry is configured to store intermediate visual data and prompt sentences for each panel in a storage device as panel-level checkpoints, and to retrieve unaffected panel checkpoints from the storage device during reconstruction to avoid redundant reprocessing.

13. The system according to claim 1, wherein the circuitry is configured to apply a multi-modal emotion analysis function to emotion information comprising at least one of facial expression data, voice data, or interaction pattern data received from the terminal device, and to classify the emotion information into a predefined category prior to correcting the prompt sentence and the layout information.

14. The system according to claim 13, wherein the circuitry is configured to apply a category-specific correction template from a template library stored in a storage device based on the classified emotion category, and to incorporate the correction template parameters into the prompt sentence and the layout information.

15. The system according to claim 1, wherein the circuitry is configured to generate a plurality of prompt sentence variants by applying different expression style parameters derived from the structured information, transmit each variant to the generative neural network model, obtain a corresponding plurality of visual data items, and select the visual data item whose content best matches the structured information based on a relevance scoring function prior to generating the content page.

16. The system according to claim 15, wherein the circuitry is configured to apply a perceptual quality scoring function to the plurality of visual data items to assign a quality score based on resolution and content coherence, and to exclude visual data items with quality scores below a threshold from the relevance scoring function.

17. The system according to claim 1, wherein the circuitry is configured to apply a structured information versioning function to store each version of the structured information generated from the language data and the additional language data in a storage device in association with a timestamp, and to provide a version history to the terminal device upon request to enable selective rollback to a prior structured information version.

18. A system comprising:
circuitry configured to:
receive, via a communication interface coupled to a packet-switched network, language data from a terminal device, apply a natural language processing algorithm to extract structured information comprising a subject, key terms, an expression style, and a use purpose, and generate a prompt sentence for a generative neural network model for image generation based on the structured information;
transmit the prompt sentence to the generative neural network model via the communication interface to obtain visual data, determine layout information comprising page size, panel arrangement, and panel order based on the visual data and the structured information, and generate a content page comprising a plurality of panels;
receive additional language data from the terminal device via the communication interface, update the structured information based on the additional language data, regenerate at least one of the prompt sentence and the visual data, and reconstruct at least a part of the layout information and the content page based on the regeneration result;
analyze emotion information associated with a user using an emotion analysis algorithm, and correct at least one of the prompt sentence and the layout information to conform to the emotion information; and
generate output data of the content page in at least one of an image format and a document format, and transmit the output data to the terminal device via the communication interface.

19. The system according to claim 18, wherein the circuitry is configured to apply a change detection function to identify the subset of panels affected by the additional language data, limit regeneration to the affected subset, and retrieve unaffected panel checkpoints from a storage device to avoid redundant reprocessing.

20. A method comprising:
receiving, via a communication interface coupled to a packet-switched network, language data from a terminal device, analyzing the language data using a natural language processing algorithm, and extracting structured information comprising at least a subject, key terms, an expression style, and a use purpose;
generating a prompt sentence for a generative neural network model for image generation based on the structured information, transmitting the prompt sentence to the generative neural network model via the communication interface, and obtaining visual data generated by the generative neural network model;
determining layout information comprising at least a page size, panel arrangement, and panel order based on the visual data and the structured information, and generating a content page comprising a plurality of panels by arranging the visual data according to the layout information;
receiving additional language data from the terminal device via the communication interface, analyzing the additional language data to update the structured information, regenerating at least one of the prompt sentence and the visual data based on the updated structured information, and reconstructing at least a part of the layout information and the content page; and
analyzing emotion information associated with a user using an emotion analysis algorithm, correcting at least one of the prompt sentence and the layout information to conform to the emotion information, generating output data of the content page, and transmitting the output data to the terminal device via the communication interface.
